(19) United States
(12) Patent Application Publication
(10) Pub. No.: US 2009/0059368 A1
(43) Pub. Date: Mar. 5, 2009

(54) OPTICAL FILM, AND GLASS

(75) Inventor: Koh Kamada, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/181,035

(22) Filed: Jul. 28, 2008

(30) Foreign Application Priority Data
Aug. 27, 2007 (JP) 2007-220163

(51) Int. Cl. G02B 5/30; G02B 1/08

(52) U.S. Cl. 359/494; 977/773

(57) ABSTRACT

The present invention provides glass containing a base, and an optical film, wherein the optical film contains a vertically polarizing film having a polarizer whose absorption axis is substantially vertically oriented to a film surface, and a π/2 optical rotation film containing an optical rotator for rotating a vibration direction of linearly polarized light by substantially 90 degrees.

### BACKGROUND OF THE INVENTION

1. Field of the Invention

The present invention relates to an optical film suitably used for windshields and side window glasses of all kinds of vehicles, and also relates to glass using the optical film.

2. Description of the Related Art

As a method for suppressing unwanted reflections (specifically, surrounding views reflected on glass) of an image on the front window (windshield) of a vehicle from the dashboard inside the vehicle, the inventor of the present invention has proposed a method in which a polarizing film containing a horizontal polarizer which absorbs S wave is used for a windshield of a vehicle so as to absorb the S wave of reflected light, thereby suppressing unwanted reflections on glass (Japanese Patent Application Laid-Open (JP-A) No. 2007-334150).

The inclination angle of windshields used in common private cars has been approximately 30 degrees in order to reduce air resistance for about 20 years. Thus, an image reflected on an interior surface (or a back surface which is opposite from a surface from which the sunlight is incident) of the windshield from the dashboard is caused by a reflected light having an incident angle of approximately 60 degrees to the surface of the windshield, in which S wave polarization component is dominant. According to JP-A No. 2007-334150, such an S wave is absorbed by a horizontally polarizing film, so that the total effect of prevention of unwanted reflections on glass is significantly increased and safety is improved. Moreover, a dashboard can be flexibly designed. However, a horizontal polarizer used alone can be effective to obtain sufficient prevention of unwanted reflections in the region of the windshield right in front of the driver, but not effective to obtain sufficient prevention of unwanted reflections obliquely in front of the windshield and side window glasses. This may be caused for the following reason: when a line-of-sight azimuth angle is focused on among angles formed by the line of sight of the driver and the windshield, the region in front of the driver is defined as an azimuth angle of 0 degree, as the line of sight is moved to a passenger side, the line-of-sight azimuth angle is gradually increased, and then an angle formed by S wave of reflected light and a horizontal polarizer is shifted from 0 degree, thereby decreasing the effect of suppressing unwanted reflections on glass.

Moreover, various shapes of windshields are adopted to vehicles such as automobiles depending on kinds of vehicles. A windshield is sufficiently effective in prevention of unwanted reflections in a shape used in an ordinary automobile, but not in a shape of substantially spherical surface used in a sports car, and the line-of-sight azimuth angle may largely shift from 90 degrees even right in front of the driver. The market research of automobile manufacturers reveals that the problem of unwanted reflections occurs not only in the windshield but also in side window glasses of the driver seat. A windshield of a bus is substantially flat, and unwanted reflections may not occur right in front of the driver, where an incident angle is 0 degree. However, bus drivers often perform confirmation operation covering field of view of 180 degrees, and often visually check the area corresponding to the line-of-sight azimuth angle of 60 degrees to 90 degrees and elevation angle of approximately 30 degrees for the purpose of checking the left side when turning left. Moreover, passengers switch on interior lights at night, and even though light is shielded by a partition board placed just behind the driver, strong unwanted reflections is caused by the interior lights from the left hand field of view of the driver. That is, in consideration of the above problems, it has been found that prevention of unwanted reflections cannot be sufficiently obtained by using only a horizontal polarizing plate for windshields and side window glasses of various types of vehicles.

Chemical Physics Letters 398 (2004) 224-227 discloses a polarizing film that seems to have a vertically oriented polarizer in terms of the production method and dichroic data. Moreover, FIG. 1 of JP-A No. 2006-503325 shows a polarization arrangement having a vertical polarizer.

However, the polarizing films containing only these vertical polarizers can remove only P wave, which is different from the light of unwanted reflections in which S wave is dominant that is found by the inventor of the present invention. Therefore, as it now stands, such a polarizing film is not effective for prevention of unwanted reflections on glass.

### BRIEF SUMMARY OF THE INVENTION

The present invention aims to provide an optical film having excellent prevention of unwanted reflections in wide areas including a whole area of a windshield and side window glasses in various kinds of vehicles, outstandingly improved antireflection effect of an interior surface (a back surface) which is not influenced by shapes of windshields, and also excelling in safety, and enabling a dashboard to be flexibly designed, and to provide glass using the optical film suitably used for windshields and side window glasses in various kinds of vehicles.

The means for solving the above-mentioned problems is as follows:

<1> an optical film containing a vertically polarizing film having a polarizer whose absorption axis is substantially vertically oriented to a film surface, and a π/2 optical rotation film containing an optical rotator for rotating a vibration direction of linearly polarized light by substantially 90 degrees.
<2> The optical film according to <1>, wherein the π/2 optical rotation film is formed on both surfaces of the vertically polarizing film.
<3> The optical film according to any one of <1> and <2>, further containing an antireflection film.
<4> The optical film according to any one of <1> to <3>, wherein the absorption axis of the polarizer in the vertically polarizing film is oriented at an angle of 80 degrees to 90 degrees to a surface of the vertically polarizing film.
<5> The optical film according to any one of <1> to <4>, wherein the polarizer contains an anisotropically absorbing material.
<6> The optical film according to <5>, wherein the anisotropically absorbing material is any one of a dichroic dye, anisotropic metal nanoparticle and carbon nanotube.
<7> The optical film according to <6>, wherein the anisotropic metal nanoparticle contains at least one selected from gold, silver, copper and aluminum.
<8> A glass containing at least a base, and the optical film according to any one of <1> to <7>.
<9> The glass according to <8>, wherein when the glass is placed so that sunlight is incident from one surface of the base, the optical film is located on the other surface of the base from which the sunlight is not incident.
<10> The glass according to <9>, wherein the base is a laminated glass in which an intermediate layer is provided in between two glass plates, and the intermediate layer contains an optical film.
<11> The glass according to any one of <8> to <10>, wherein the glass can be used for at least any of a windshield and side window glass of a vehicle.
<12> The glass according to <11>, wherein the vehicle is an automobile.

### BRIEF DESCRIPTION OF THE SEVERAL VIEWS OF THE DRAWINGS

FIG. 1 shows an example of an optical film of the present invention.

FIG. 2 shows another example of an optical film of the present invention.

FIG. 3 shows an example of an absorption spectrum of gold nanorods.

FIG. 4 is an explanatory view of a principle of prevention of unwanted reflections when glass of the present invention is used for a windshield of an automobile.

FIG. 5 is a graph showing how reflectance changes when a light enters from a medium having a reflectance of 1 to a medium having a reflectance of 1.46.

FIG. 6 is a view showing an example that a polarizing film is formed as an intermediate layer of a laminated glass.

FIG. 7 is a view showing an example that a polarizing film is formed in one surface of a laminated glass.

FIG. 8 is an example of an explanatory view of a method of evaluating unwanted reflections on glass in Examples.

FIG. 9 shows an example of a method of evaluating unwanted reflections on glass at azimuth angles of 0 degree and 45 degrees in FIG. 8.

### DETAILED DESCRIPTION OF THE INVENTION

### (Optical Film)

An optical film of the present invention contains a vertically polarizing film in which an absorption axis of a polarizer is substantially vertically oriented to a film surface, a π/2 optical rotation film containing an optical rotator for rotating a vibration direction of linearly polarized light by substantially 90 degrees, and an antireflection film, and further contains other components as necessary.

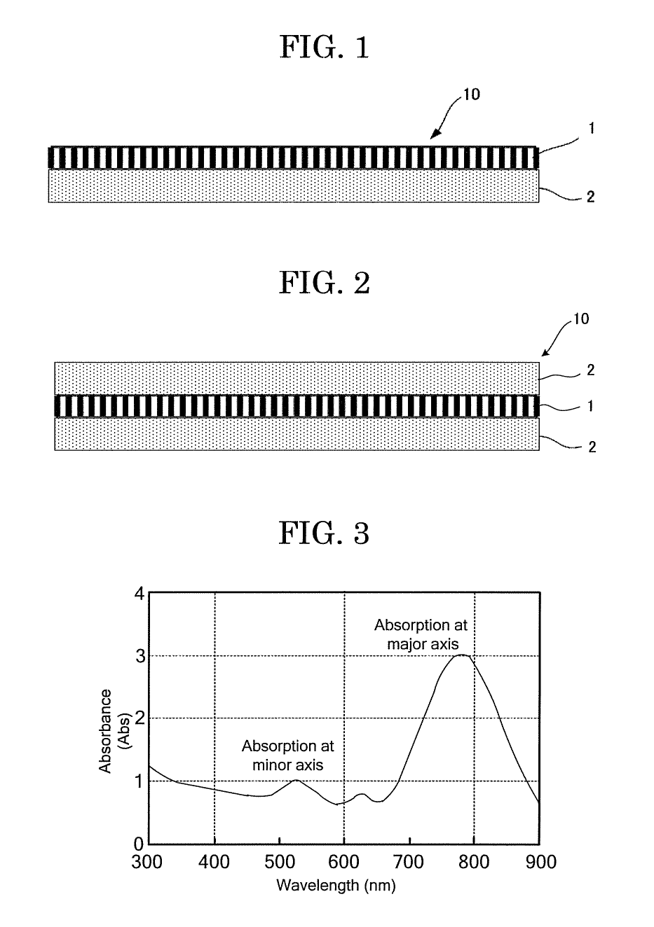

In the optical film of the present invention, the vertically polarizing film and the π/2 optical rotation film are not particularly limited as long as they are layered as shown in FIG. 1, and may be suitably selected in accordance with the intended use. Light is incident from either the vertically polarizing film 1 or π/2 optical rotation film 2.

Moreover, as shown in FIG. 2, the π/2 optical rotation films 2 are formed on both surfaces of the vertically polarizing film 1 so as to form a concentric polarizer which effectively exhibits reflection prevention effect of interior surface (or back surface which is opposite from the surface from which light is incident).

An antireflection film (not shown) may be formed in the outermost surface of an optical film 10 shown in FIGS. 1 and 2.

### <Vertically Polarizing Film>

The vertically polarizing film contains at least a polarizer whose absorption axis is substantially vertically oriented to a film surface, and further contains other components such as a dispersing agent, solvent, binder resin and the like, as necessary.

### —Polarizer—

The absorption axis of the polarizer is oriented substantially vertically to the polarizing film surface. By orienting the absorption axis of the polarizer substantially vertically to the polarizing film surface (horizontal surface), the film has a high transmittance when seen from the front face, but it has a low transmittance when seen from oblique directions, because more longitudinal waves are absorbed as the film is seen at oblique angles.

The absorption axis of the polarizer means an axis that is parallel to a direction of the minimum absorptance when the polarizer is observed from all the directions.

As used herein, “substantially vertical direction (substantially vertically orient)” means that the absorption axis of the polarizer is oriented at angles of 80 degrees to 90 degrees to the polarizing film surface (horizontal surface). The absorption axis of the polarizer is preferably oriented at angles of 85 degrees to 90 degrees and more preferably oriented vertically (at an angle of 90 degrees) to the polarizing film surface. When the angle of the absorption axis of the polarizer to the polarizing film surface is less than 80 degrees, the transmittance when seen from the front face may decrease.

Here, whether or not the absorption axis of the polarizer is oriented in a substantially vertical direction to the horizontal reference plane of the polarizing film can be checked by observing the cross-section of the polarizing film through a polarizing microscope.

When the polarizer is composed of inorganic particles, the polarizer has an average aspect ratio is preferably 1.5 or more, more preferably 1.6 or more, and still more preferably 2.0 or more. When the average aspect ratio is 1.5 or more, the polarizer can sufficiently exert an anisotropically absorbing effect.

Here, the average aspect ratio of the polarizer can be determined by measuring the major axis length and the minor axis length of the polarizer and using the following expression, (the major axis length of the polarizer)/(the minor axis length of the polarizer).

The minor axis length of the polarizer is not particularly limited and may be suitably selected in accordance with the intended use, and it is preferably 1 nm to 50 nm and more preferably 5 nm to 30 nm. The major axis of the polarizer is not particularly limited and may be suitably selected in accordance with the intended use, and it is preferably 10 nm to 1,000 nm and more preferably 10 nm to 100 nm.

The polarizer is not particularly limited and may be suitably selected in accordance with the intended use. Examples thereof include dichroic dyes, anisotropic metal nanoparticles, carbon nanotubes and metal complexes. Of these, dichroic dyes, anisotropic metal nanoparticles and carbon nanotubes are particularly preferable.

### —Dichroic Dye—

Examples of the dichroic dyes include azo dyes and anthraquinone dyes. These may be used alone or in combination.

In the present invention, the dichroic dye is defined as a compound having a light absorption function. The dichroic dye may have any absorption maximum and light absorption band, and a dichroic dye having an absorption maximum in the yellow region (Y), magenta region (M) or cyan region (C) is preferably used. Two or more dichroic dyes may be used, a mixture of dichroic dyes having an absorption maximum at Y, M or C regions is preferably used, and dichroic dyes mixed so as to absorb light over the entire visible region (400 nm to 750 nm) is more preferably used. Here, the yellow region covers a range of 430 nm to 500 nm, the magenta region covers 500 nm to 600 nm, and the cyan region covers 600 nm to 750 nm.

Here, a chromophore used for the dichroic dyes will be explained below. The chromophore of the dichroic dyes is not particularly limited and may be suitably selected in accordance with the intended use. Examples thereof include azo dyes, anthraquinone dyes, perylene dyes, merocyanine dyes, azomethine dyes, phthaloperylene dyes, indigo dyes, azulene dyes, dioxazine dyes, polythiophene dyes, and phenoxazine dyes. Of these, azo dyes, anthraquinone dyes and phenoxazone dyes are preferable, and anthraquinone dyes and phenoxazine dyes (phenoxazine-3-on) are still more preferable.

Examples of azo dyes include monoazo dyes, bisazo dyes, trisazo dyes, tetrakisazo dyes, and pentakisazo dyes. Of these, monoazo dyes, bisazo dyes, and trisazo dyes are particularly preferable.

Examples of the ring structures contained in azo dyes include aromatic groups such as benzene rings and naphthalene rings; heterocyclic rings such as quinoline rings, pyridine rings, thiazole rings, benzothiazole rings, oxazole rings, benzooxazole rings, imidazole rings, benzimidazole rings and pyrimidine rings.

Substituents of anthraquinone dyes are preferably those containing an oxygen atom, a sulfur atom or a nitrogen atom. Examples thereof include an alkoxy group, aryloxy group, alkylthio group, arylthio group, alkylamino group, and arylamino group. The number of the substituents is not particularly limited, and di-substitution, tri-substitution, and tetrakis-substitution are preferable, and di-substitution and tri-substitution are particularly preferable. The substituent may be substituted at any sites, and it is preferably 1,4-di-substituted structure, 1,5-di-substituted structure, 1,4,5-tri-substituted structure, 1,2,4-tri-substituted structure, 1,2,5-tri-substituted structure, 1,2,4,5-tetra-substituted structure or 1,2,5,6-tetra-substituted structure.

For the substituent of the phenoxazone dye (phenoxazine-3-on), those containing an oxygen atom, a sulfur atom or a nitrogen atom are preferable. Examples thereof include an alkoxy group, aryloxy group, alkylthio group, arylthio group, alkylamino group and arylamino group.

The dichroic dye used in the present invention preferably has a substituent expressed by the following General Formula (1):

-(Het)ⱼ-{(B¹)ₚ-(Q¹)_{q}-(B²)ᵣ}ₙ—C¹ General Formula (1)

where, Het represents an oxygen atom or a sulfur atom; B¹ and B² each independently represents an arylene group, a heteroarylene group or a divalent cyclic aliphatic hydrocarbon group; Q¹ represents a divalent linkage group; C¹ represents an alkyl group, a cycloalkyl group, an alkoxy group, an alkoxy carbonyl group, an acyl group or an acyloxy group; “j” represents 0 or 1; “p”, “q” or “r” each independently represents an integer of 0 to 5; “n” represents an integer of 1 to 3; (p+r)×n equals an integer of 3 to 10, i.e., a value of “p” plus “r” multiplied by an integer of “n” is an integer any one of integers 3 to 10, when “p”, “q” or “r” is 2 or more, B¹s, Q¹s and B²s may be respectively identical or different, and when “n” is 2 or more, 2 or more of {(B¹)ₚ-(Q¹)_{q}-(B²)ᵣ} may be identical or different.

Het is an oxygen atom or a sulfur atom and particularly preferably a sulfur atom.

B¹ and B² each independently represents an arylene group, a heteroarylene group or a divalent cyclic aliphatic hydrocarbon group, which may or may not have a substituent.

The arylene group represented by B¹ or B² is an arylene group preferably having 6 to 20 carbon atoms, more preferably having 6 to 10 carbon atoms. The arylene group is preferably a benzene ring group, naphthalene ring group and anthracene ring group, more preferably a benzene ring group and substituted benzene ring group, and still more preferably a 1,4-phenylene group.

The heteroarylene group represented by B¹ or B² is a heteroarylene group preferably having 1 to 20 carbon atoms and more preferably having 2 to 9 carbon atoms. Examples of heteroarylene groups include groups of pyridine ring, quinoline ring, isoquinoline group, pyrimidine ring, pyrazine ring, thiophene ring, furan ring, oxazole ring, thiazole ring, imidazole ring, pyrazole ring, oxadiazole ring, thiadiazole ring and triazole ring, and heteroarylene rings formed by condensation of the above-mentioned groups.

The divalent cyclic aliphatic hydrocarbon group represented by B¹ or B² is a divalent cyclic aliphatic hydrocarbon group preferably having 3 to 20 carbon atoms and more preferably having 4 to 10 carbon atoms. For example, the divalent cyclic aliphatic hydrocarbon groups are preferably cyclohexanediyl and cyclopentanediyl, more preferably cyclohexane-1,2-diyl group, cyclohexane-1,3-diyl group, cyclohexane-1,4-diyl group, cyclopentane-1,3-diyl group, and particularly preferably cyclohexane-1,4-diyl group.

The divalent arylene group, the heteroarylene group and the divalent cyclic aliphatic hydrocarbon group respectively represented by B¹ or B² may further have substituents. Examples of the substituents include the following substituent groups V.

### [Substituent Groups V]

Examples of the substituent groups V are as follows: halogen atoms (for example, a chlorine atom, bromine atom, iodine atom, and fluorine atom); mercapto groups, cyano groups, carboxyl groups, phosphoric groups, sulfo groups, hydroxy groups; carbamoyl groups having 1 to 10 carbon atoms, preferably having 2 to 8 carbon atoms, and more preferably having 2 to 5 carbon atoms (for example, a methylcarbamoyl group, ethylcarbamoyl group, and morpholino carbamoyl group); sulfamoyl groups having 0 to 10 carbon atoms, preferably having 2 to 8 carbon atoms, and more preferably having 2 to 5 carbon atoms (for example, a methylsulfamoyl group, ethylsulfamoyl group, and piperidinosulfonyl group); nitro groups; alkoxy groups having 1 to 20 carbon atoms, preferably having 1 to 10 carbon atoms, and more preferably having 1 to 8 carbon atoms (for example, a methoxy group, ethoxy group, 2-methoxyethoxy group, and 2-phenylethoxy group); aryloxy groups having 6 to 20 carbon atoms, preferably having 6 to 12 carbon atoms, and more preferably having 6 to 10 carbon atoms (for example, a phenoxy group, p-methylphenoxy group, p-chlorophenoxy group, and naphthoxy group); acyl groups having 1 to 20 carbon atoms, preferably having 2 to 12 carbon atoms, and more preferably having 2 to 8 carbon atoms (for example, an acetyl group, benzoyl group, and trichloroacetyl group); acyloxy groups having 1 to 20 carbon atoms, preferably having 2 to 12 carbon atoms, and more preferably having 2 to 8 carbon atoms (for example, an acetyloxy group and benzoyloxy group); acylamino groups having 1 to 20 carbon atoms, preferably having 2 to 12 carbon atoms, and more preferably having 2 to 8 carbon atoms (for example, an acetylamino group); sulfonyl groups having 1 to 20 carbon atoms, preferably having 1 to 10 carbon atoms, and more preferably having 1 to 8 carbon atoms (for example, a methanesulfonyl group, ethanesulfonyl group, and benzenesulfonyl group); sulfinyl groups having 1 to 20 carbon atoms, preferably having 1 to 10 carbon atoms, and more preferably 1 to 8 carbon atoms (for example, a methanesulfinyl group, ethanesulfinyl group, and benzenesulfinyl group); unsubstituted or substituted amino groups having 1 to 20 carbon atoms, preferably having 1 to 12 carbon atoms, and more preferably having 1 to 8 carbon atoms (for example, an amino group, methylamino group, dimethylamino group, benzylamino group, anilino group, diphenylamino group, 4-methylphenylamino group, 4-ethylphenylamino group, 3-n-propylphenylamino group, 4-n-propylphenylamino group, 3-n-butylphenylamino group, 4-n-butylphenylamino group, 3-n-pentylphenylamino group, 4-n-pentylphenylamino group, 3-trifluoromethylphenylamino group, 4-trifluoromethylphenylamino group, 2-pyridylamino group, 3-pyridylamino group, 2-thiazolylamino group, 2-oxazolylamino group, N,N-methylphenylamino group and N,N-ethylphenylamino group); ammonium groups having 0 to 15 carbon atoms, preferably having 3 to 10 carbon atoms, and more preferably having 3 to 6 carbon atoms (for example, a trimethylammonium group and triethylammonium group); hydrazino groups having 0 to 15 carbon atoms, preferably having 1 to 10 carbon atoms, and more preferably having 1 to 6 carbon atoms (for example, a trimethylhydrazino group); ureide groups having 1 to 15 carbon atoms, preferably having 1 to 10 carbon atoms, and more preferably having 1 to 6 carbon atoms (for example, an ureide group, N,N-dimethylureide group); imide groups having 1 to 15 carbon atoms, preferably having 1 to 10 carbon atoms, and more preferably having 1 to 6 carbon atoms (for example, a succinimide group); alkylthio groups having 1 to 20 carbon atoms, preferably having 1 to 12 carbon atoms, and more preferably having 1 to 8 carbon atoms (for example, a methylthio group, ethylthio group, and propylthio group); arylthio groups having 6 to 80 carbon atoms, preferably having 6 to 40 carbon atoms, and more preferably having 6 to 30 carbon atoms (for example, a phenylthio group, p-methylphenylthio group, p-chlorophenylthio group, 2-pyridylthio group, 1-naphthylthio group, 2-naphthylthio group, 4-propylcyclohexyl-4′-biphenylthio group, 4-butylcyclohexyl-4′-biphenylthio group, 4-pentylcyclohexyl-4′-biphenylthio group, and 4-propylphenyl-2-ethynyl-4′-biphenylthio group); heteroarylthio groups having 1 to 80 carbon atoms, preferably having 1 to 40 carbon atoms, and more preferably having 1 to 30 carbon atoms (for example, a 2-pyridylthio group, 3-pyridylthio group, 4-pyridylthio group, 2-quinolylthio group, 2-furylthio group, and 2-pyrrolylthio group); alkoxycarbonyl groups having 2 to 20 carbon atoms, preferably having 2 to 12 carbon atoms, and more preferably 2 to 8 carbon atoms (for example, a methoxycarbonyl group, ethoxycarbonyl group, and 2-benzyloxycarbonyl group); aryloxycarbonyl groups having 6 to 20 carbon atoms, preferably having 6 to 12 carbon atoms, and more preferably having 6 to 10 carbon atoms (for example, a phenoxycarbonyl group), unsubstituted alkyl groups having 1 to 18 carbon atoms, preferably having 1 to 10 carbon atoms, and more preferably having 1 to 5 carbon atoms (for example, a methyl group, ethyl group, propyl group, and butyl group); substituted alkyl groups having 1 to 18 carbon atoms, preferably having 1 to 10 carbon atoms, and more preferably having 1 to 5 carbon atoms (for example, a hydroxymethyl group, trifluoromethyl group, benzyl group, carboxyethyl group, ethoxycarbonylmethyl group, acetylaminomethyl group; here, examples of the substituted alkyl groups also include unsaturated hydrocarbon groups having 2 to 18 carbon atoms, preferably having 3 to 10 carbon atoms, and more preferably having 3 to 5 carbon atoms (for example, a vinyl group, ethynyl group, 1-cyclohexenyl group, benzylidyne group, and benzylidene group)); unsubstituted or substituted aryl groups having 6 to 20 carbon atoms, preferably having 6 to 15 carbon atoms, and more preferably having 6 to 10 carbon atoms (for example, a phenyl group, naphthyl group, p-carboxyphenyl group, p-nitrophenyl group, 3,5-dichlorophenyl group, p-cyanophenyl group, m-fluorophenyl group, p-tolyl group, 4-propylcyclohexyl-4′-biphenyl group, 4-butylcyclohexyl-4′-biphenyl group, 4-pentylcyclohexyl-4′-biphenyl group, and 4-propylphenyl-2-ethynyl-4′-biphenyl group); and unsubstituted or substituted heteroaryl groups having 1 to 20 carbon atoms, preferably having 2 to 10 carbon atoms, and more preferably having 4 to 6 carbon atoms (for example, a pyridyl group, 5-methylpyridyl group, thienyl group, furyl group, morpholino group, and tetrahydrofulfuryl group).

These substituent groups V can also respectively have a structure in which a benzene ring and a naphthalene ring are condensed. Further, these substituent groups V may be respectively substituted by the substituents explained above in the substituent groups V.

As the substituent groups V preferred are the above-mentioned alkyl groups, aryl groups, alkoxy groups, aryloxy groups, halogen atoms, amino groups, substituted amino groups, hydroxy groups, alkylthio groups, and arylthio groups. The substituent groups V are more preferably the above-noted alkyl groups, aryl groups and halogen atoms.

In General Formula (1), Q¹ represents a divalent linkage group. Examples of linkage group include linkage groups of atom groups composed of at least one atom selected from a carbon atom, nitrogen atom, sulfur atom, and oxygen atom. Examples of the divalent linkage groups represented by Q¹ include divalent linkage groups having 0 to 60 carbon atoms which are composed of the following groups alone or in combination: alkylene groups preferably having 1 to 20 carbon atoms and more preferably having 1 to 10 carbon atoms (for example, a methylene group, ethylene group, propylene group, butylene group, pentylene group, and cyclohexyl-1,4-diyl group), alkenylene groups preferably having 2 to 20 carbon atoms and more preferably having 2 to 10 carbon atoms (for example, an ethenylene group), alkynylene groups having 2 to 20 carbon atoms and more preferably having 2 to 10 carbon atoms (for example, an ethynylene group), amide groups, ether groups, ester groups, sulfonamide groups, sulfonic ester groups, ureide groups, sulfonyl groups, sulfinyl groups, thioether groups, carbonyl groups, —NR— groups (where, R represents a hydrogen atom, an alkyl group or an aryl group; the alkyl group represented by R is preferably an alkyl group having 1 to 20 carbon atoms and more preferably having 1 to 10 carbon atoms, and the aryl group represented by R is preferably an aryl group having 6 to 14 carbon atoms and more preferably having 6 to 10 carbon atoms.), azo groups, azoxy groups, and heterocyclic divalent groups (heterocyclic divalent groups preferably having 2 to 20 carbon atoms and more preferably 4 to 10 carbon atoms, for example a piperazine-1,4-diyl group).

As the divalent linkage groups represented by Q¹ preferred are alkylene groups, alkenylene groups, alkynylene groups, ether groups, thioether groups, amide groups, ester groups, carbonyl groups and combinations thereof.

Q¹ may further have a substituent, and examples of the substituents include the above-mentioned substituent groups V.

In General Formula (1), C¹ represents an alkyl group, a cycloalkyl group, an alkoxy group, an alkoxycarbonyl group, an acyl group or an acyloxy group. The alkyl group, cycloalkyl group, alkoxy group, alkoxycarbonyl group, acyl group or acyloxy group represented by C¹ include those having a substituent.

C¹ represents an alkyl group and a cycloalkyl group respectively having 1 to 30 carbon atoms, preferably having 1 to 12 carbon atoms, and still more preferably having 1 to 8 carbon atoms (for example, a methyl group, ethyl group, propyl group, butyl group, t-butyl group, i-butyl group, s-butyl group, pentyl group, t-pentyl group, hexyl group, heptyl group, octyl group, cyclohexyl group, 4-methylcyclohexyl group, 4-ethylcychohexyl group, 4-propylcyclohexyl group, 4-butylcyclohexyl group, 4-pentylcyclohexyl group, hydroxymethyl group, trifluoromethyl group, and benzyl group), an alkoxy group having 1 to 20 carbon atoms, preferably having 1 to 10 carbon atoms, and more preferably having 1 to 8 carbon atoms (for example, a methoxy group, ethoxy group, 2-methoxyethoxy group, and 2-phenylethoxy group), an acyloxy group having 1 to 20 carbon atoms, preferably having 2 to 12 carbon atoms, and more preferably having 2 to 8 carbon atoms (for example, an acetyloxy group, and benzoyloxy group), an acyl group having 1 to 30 carbon atoms, preferably having 1 to 12 carbon atoms, and more preferably having 1 to 8 carbon atoms (for example, an acetyl group, formyl group, pivaloyl group, 2-chloroacetyl group, stearoyl group, benzoyl group, and p-n-octyloxyphenylcarbonyl group), or an alkoxycarbonyl group having 2 to 20 carbon atoms, preferably having 2 to 12 carbon atoms, and more preferably having 2 to 8 carbon atoms (for example, a methoxycarbonyl group, ethoxycarbonyl group, and 2-benzyloxycarbonyl group).

C¹ is preferably an alkyl group or an alkoxy group, more preferably an ethyl group, a propyl group, a butyl group, a pentyl group, a hexyl group, or a trifluoromethoxy group.

C¹ may further have a substituent, and examples of the substituent include the above-mentioned substituent groups V.

Of the substituent groups V, the substituent of alkoxy group represented by C¹ is, for example, preferably a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, an aryloxycarbonyl group or the like.

Of the substituent groups V, the substituent of cycloalkyl group represented by C¹ is, for example, preferably a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, an aryloxycarbonyl group, an alkyl group or the like.

Of the substituent groups V, the substituent of alkoxy group represented by C¹ is, for example, preferably a halogen atom (particularly, a fluorine atom), a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, an aryloxycarbonyl group or the like.

Of the substituent groups V, the substituent of alkoxycarbonyl group represented by C¹ is, for example, preferably a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, an aryloxycarbonyl group or the like.

Of the substituent groups V, the substituent of acyl group represented by C¹ is, for example, preferably a halogen atom, a cyano group, a hydroxy group, a carbamoyl group, an alkoxy group, an aryloxy group, an acyl group, an acyloxy group, an acylamino group, an alkylthio group, an arylthio group, a heteroarylthio group, an alkoxycarbonyl group, an aryloxycarbonyl group or the like.

Of the substituent groups V, the substituent of acyloxy group represented by C¹ is, for example, preferably a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxycarbonyl group, an aryloxycarbonyl group or the like.

In General Formula (1), “j” represents 0 or 1, and preferably 0.

“p”, “q” and “r” each independently represents an integer of 0 to 5; “n” represents an integer of 1 to 3; the total number of groups represented by B¹ and B², i.e., (p+r)×n, is an integer of 3 to 10, and more preferably an integer of 3 to 5.

When “p”, “q” or “r” is 2 or more, B¹s, Q¹s and B²s may be respectively identical or different, and when “n” is 2 or more, 2 or more of {(B¹)ₚ-(Q¹)_{q}-(B²)ᵣ} may be identical or different.

Combinations of “p”, “q”, “r”, and “n” are preferably as follows:

(i) p=3, q=0, r=0, n=1
(ii) p=4, q=0, r=0, n=1
(iii) p=5, q=0, r=0, n=1
(iv) p=2, q=0, r=1, n=1
(v) p=2, q=1, r=1, n=1
(vi) p=1, q=1, r=2, n=1
(vii) p=3, q=1, r=1, n=1
(viii) p=2, q=0, r=2, n=1
(ix) p=1, q=1, r=1, n=2
(x) p=2, q=1, r=1, n=2

Of these combinations, (i) p=3, q=0, r=0, n=1; (iv) p=2, q=0, r=1, n=1; and (v) p=2, q=1, r=1, n=1 are particularly preferable.

Note that -{(B¹)ₚ-(Q¹)_{q}-(B²)ᵣ}ₙ—C¹ preferably contains a partial structure exhibiting liquid crystallinity. For the “liquid crystal” mentioned in the present invention, any phases may be used, and it is preferably a nematic liquid crystal, a smectic liquid crystal or a discotic liquid crystal, and is particularly preferably a nematic liquid crystal.

The specific examples of the -{(B¹)ₚ-(Q¹)_{q}-(B²)ᵣ}ₙ—C¹ are as follows, but not limited thereto. In the following chemical formulas, each of the wavy lines represents a linkage site.

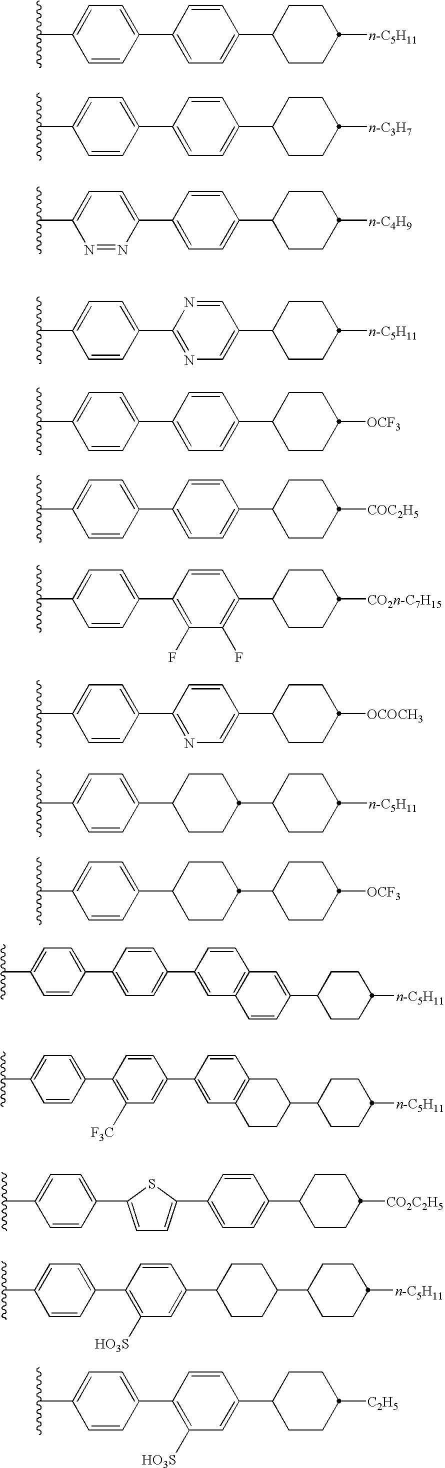

The dichroic dye used in the present invention preferably has one or more substituents represented by -{(B¹)ₚ-(Q¹)_{q}-(B²)ᵣ}ₙ—C¹, more preferably has 1 to 8 substituents represented by -{(B¹)ₚ-(Q¹)_{q}-(B²)ᵣ}ₙ—C¹, still more preferably has 1 to 4 substituents represented by -{(B¹)ₚ-(Q¹)_{q}-(B²)ᵣ}ₙ—C¹, and particularly preferably has 1 or 2 substituents represented by -{(B¹)ₚ-(Q¹)_{q}-(B²)ᵣ}ₙ—C¹.

The structures of the substituent represented by General Formula (1) are preferably the following combinations:

[1] A structure in which Het is a sulfur atom, B¹ represents an aryl group or a heteroaryl group, B² represents a cyclohexane-1,4-diyl group, C¹ represents an alkyl group, “j” is 1, “p” is 2, “q” is 0, “r” is 1, and “n” is 1.

[2] A structure in which Het is a sulfur atom, B¹ represents an aryl group or a heteroaryl group, B² represents a cyclohexane-1,4-diyl group, C¹ represents an alkyl group, “j” is 1, “p” is 1, “q” is 0, “r” is 2, and “n” is 1.

The following combinations are particularly preferable:

[I] A structure represented by General Formula (a-1), where Het is a sulfur atom, B¹ represents a 1,4-phenylene group, B² represents a trans-cyclohexyl group, C¹ represents an alkyl group (preferably represents a methyl group, an ethyl group, a propyl group, a butyl group, a pentyl group or a hexyl group), “j” is 1, “p” is 2, “q” is 0, “r” is 1, and “n” is 1.

[II] A structure represented by General Formula (a-2), where Het is a sulfur atom, B¹ represents a 1,4-phenylene group, B² represents a trans-cyclohexane-1,4-diyl group, C¹ represents an alkyl group (preferably represents a methyl group, an ethyl group, a propyl group, a butyl group, a pentyl group or a hexyl group), “j” is 1, “p” is 1, “q” is 0, “r” 2, and “n” is 1.

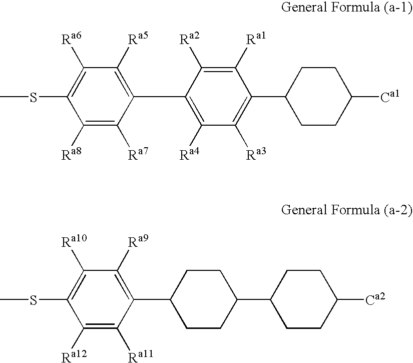

In General Formulas (a-1) and (a-2), R^{a1} to R^{a12} each independently represents a hydrogen atom or substituent. Examples of the substituents include a substituent selected from the above-mentioned substituent groups V.

Preferably, R^{a1} to R^{a12} each independently represents a hydrogen atom, a halogen atom (particularly, a fluorine atom), an alkyl group, an aryl group or an alkoxy group. Of the alkyl groups, aryl groups and alkoxy groups represented by any one of R^{a1} to R^{a12}, preferable groups are the same alkyl groups, the aryl groups and the alkoxy groups as those described in the above-mentioned substituent groups V.

In General Formulas (a-1) and (a-2), C^{a1} and C^{a2} each independently represents an alkyl group, and is preferably an alkyl group having 1 to 20 carbon atoms, and more preferably an alkyl group having 1 to 10 carbon atoms.

Particularly preferably, C^{a1} and C^{a2} each independently represents a methyl group, ethyl group, propyl group, butyl group, pentyl group, hexyl group, heptyl group, octyl group or nonyl group.

The azo dye is not particularly limited and may be a monoazo dye, a bisazo dye, a trisazo dye, a tetrakisazo dye, a pentakisazo dye and the like, and it is preferably a monoazo dye, a bisazo dye, and a trisazo dye.

Examples of the ring structures contained in azo dyes include aromatic groups such as benzene rings and naphthalene rings; heterocyclic rings such as quinoline rings, pyridine rings, thiazole rings, benzothiazole rings, oxazole rings, benzooxazole rings, imidazole rings, benzimidazole rings and pyrimidine rings.

Substituents of anthraquinone dyes are preferably those containing an oxygen atom, a sulfur atom or a nitrogen atom. Examples thereof include an alkoxy group, an aryloxy group, an alkylthio group, an arylthio group, an alkylamino group and an arylamino group.

The number of the substituents is not particularly limited and di-substitution, tri-substitution, and tetrakis-substitution are preferable, and di-substitution and tri-substitution are particularly preferable. The substituent may be substituted at any sites, and it is preferably 1,4-di-substituted structure, 1,5-di-substituted structure, 1,4,5-tri-substituted structure, 1,2,4-tri-substituted structure, 1,2,5-tri-substituted structure, 1,2,4,5-tetra-substituted structure or 1,2,5,6-tetra-substituted structure.

The anthraquinone dye is more preferably a compound represented by General Formula (2). The phenoxazone dye is more preferably a compound represented by General Formula (3).

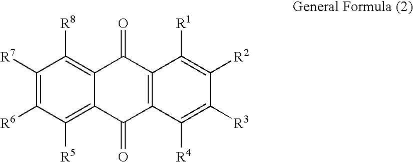

where at least one of R¹, R², R³, R⁴, R⁵, R⁶, R⁷ and R⁸ is -(Het)ⱼ-{(B¹)ₚ-(Q¹)_{q}-(B²)ᵣ}ₙ—C¹, and others are each independently a hydrogen atom or substituent.

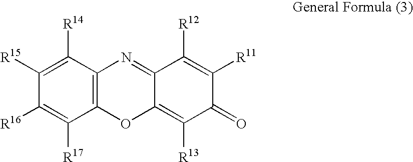

where at least one of R¹¹, R¹², R¹³, R¹⁴, R¹⁵, R¹⁶ and R¹⁷ is -(Het)ⱼ-{(B¹)ₚ-(Q¹)_{q}-(B²)ᵣ}ₙ-C¹, and others are each independently a hydrogen atom or substituent, and Het, B¹, B², Q¹, p, q, r, n and C¹ are each independently identical to those described in General Formula (1).

In General Formula (2), the substituents represented by any one of R², R³, R⁴, R⁵, R⁶, R⁷ and R⁸ are, for example, the above-mentioned substituents V, and are preferably arylthio groups having 6 to 80 carbon atoms, more preferably having 6 to 40 carbon atoms, and still more preferably having 6 to 30 carbon atoms (for example, phenylthio groups, p-methylphenylthio groups, p-chlorophenylthio groups, 4-methylphenylthio groups, 4-ethylphenylthio groups, 4-n-propylphenylthio groups, 2-n-butylphenylthio groups, 3-n-butylphenylthio groups, 4-n-butylphenylthio groups, 2-t-butylphenylthio groups, 3-t-butylphenylthio groups, 4-t-butylphenylthio groups, 3-n-pentylphenylthio groups, 4-n-pentylphenylthio groups, 4-amylpentylphenylthio groups, 4-hexylphenylthio groups, 4-heptylphenylthio groups, 4-octylphenylthio groups, 4-trifluoromethylphenylthio groups, 3-trifluoromethylphenylthio groups, 2-pyridilthio groups, 1-naphthylthio groups, 2-naphthylthio groups, 4-propylcyclohexyl-4′-biphenylthio groups, 4-butylcyclohexyl-4′-biphenylthio groups, 4-pentylcyclohexyl-4′-biphenylthio groups, and 4-propylphenyl-2-ethynyl-4′-biphenylthio groups); heteroarylthio groups having 1 to 80 carbon atoms, preferably having 1 to 40 carbon atoms, and still more preferably having 1 to 30 carbon atoms (for example, 2-pyridilthio groups, 3-pyridilthio groups, 4-pyridilthio groups, 2-quinolylthio groups, 2-furylthio groups, and 2-pyrrolylthio groups); unsubstituted or substituted alkylthio groups (for example, methylthio groups, ethylthio groups, butylthio groups, and phenethylthio groups); unsubstituted or substituted amino groups (for example, amino groups, methylamino groups, dimethylamino groups, benzylamino groups, anilino groups, diphenylamino groups, 4-methylphenylamino groups, 4-ethylphenylamino groups, 3-n-propylphenylamino groups, 4-n-propylphenylamino groups, 3-n-butylphenylamino groups, 4-n-butylphenylamino groups, 3-n-pentylphenylamino groups, 4-n-pentylphenylamino groups, 3-trifluoromethylphenylamino groups, 4-trifluoromethylphenylamino groups, 2-pyridilamino groups, 3-pyridilamino groups, 2-thiazolylamino groups, 2-oxazolylamino groups, N,N-methylphenylamino groups, and N,N-ethylphenylamino groups); halogen atoms (for example, fluorine atoms, and chlorine atoms); unsubstituted or substituted alkyl groups (for example, methyl groups, and trifluoromethyl groups); unsubstituted or substituted alkoxy groups (for example, methoxy groups, and trifluoromethoxy groups); unsubstituted or substituted aryl groups (for example, phenyl groups); unsubstituted or substituted heteroaryl groups (for example, 2-pyridil groups); unsubstituted or substituted aryloxy groups (for example, phenoxy groups); and unsubstituted or substituted heteroaryloxy groups (for example, 3-thienyloxy groups).

R², R³, R⁴, R⁵, R⁶, R⁷ and R⁸ are preferably hydrogen atoms, fluorine atoms, chlorine atoms, and unsubstituted or substituted arylthio groups, alkylthio groups, amino groups, alkylamino groups, arylamino groups, alkyl groups, aryl groups, alkoxy groups or aryloxy groups. Of these, hydrogen atoms, fluorine atoms, and unsubstituted or substituted arylthio groups, alkylthio groups, amino groups, alkylamino groups or arylamino groups are more preferable.

Still more preferably, at least one of the R¹, R⁴, R⁵, and R⁸ is -(Het)ⱼ-{(B¹)ₚ-(Q¹)_{q}-(B²)ᵣ}ₙ—C¹ in General Formula (2).

In General Formula (3), substituents represented by any one of R¹¹, R¹², R¹³, R¹⁴, R¹⁵, R¹⁶ and R¹⁷ are each independently a halogen atom, alkyl group, aryl group, alkylthio group, arylthio group, heterocyclic thio group, hydroxyl group, alkoxy group, aryloxy group, carbamoyl group, acyl group, aryloxy carbonyl group, alkoxy carbonyl group, and amide group. Of these, a hydrogen atom, halogen atom, alkyl group, arylthio group, and amide group are particularly preferable.

The substituent represented by R¹⁶ is preferably an amino group (including an alkylamino group and arylamino group), hydroxyl group, mercapto group, alkylthio group, arylthio group, alkoxy group or aryloxy group, and particularly preferably an amino group.

Specific examples of dichroic dyes which can be used in the present invention are as follows, but not limited thereto.

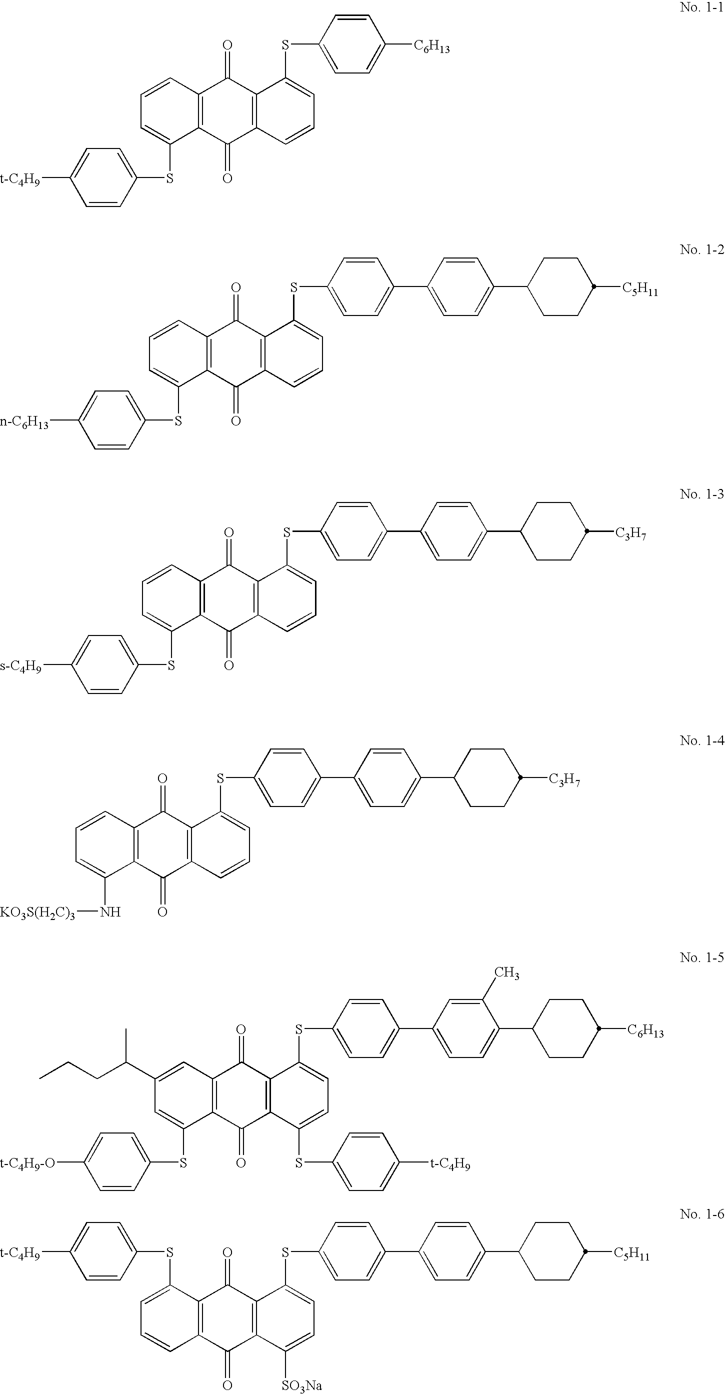

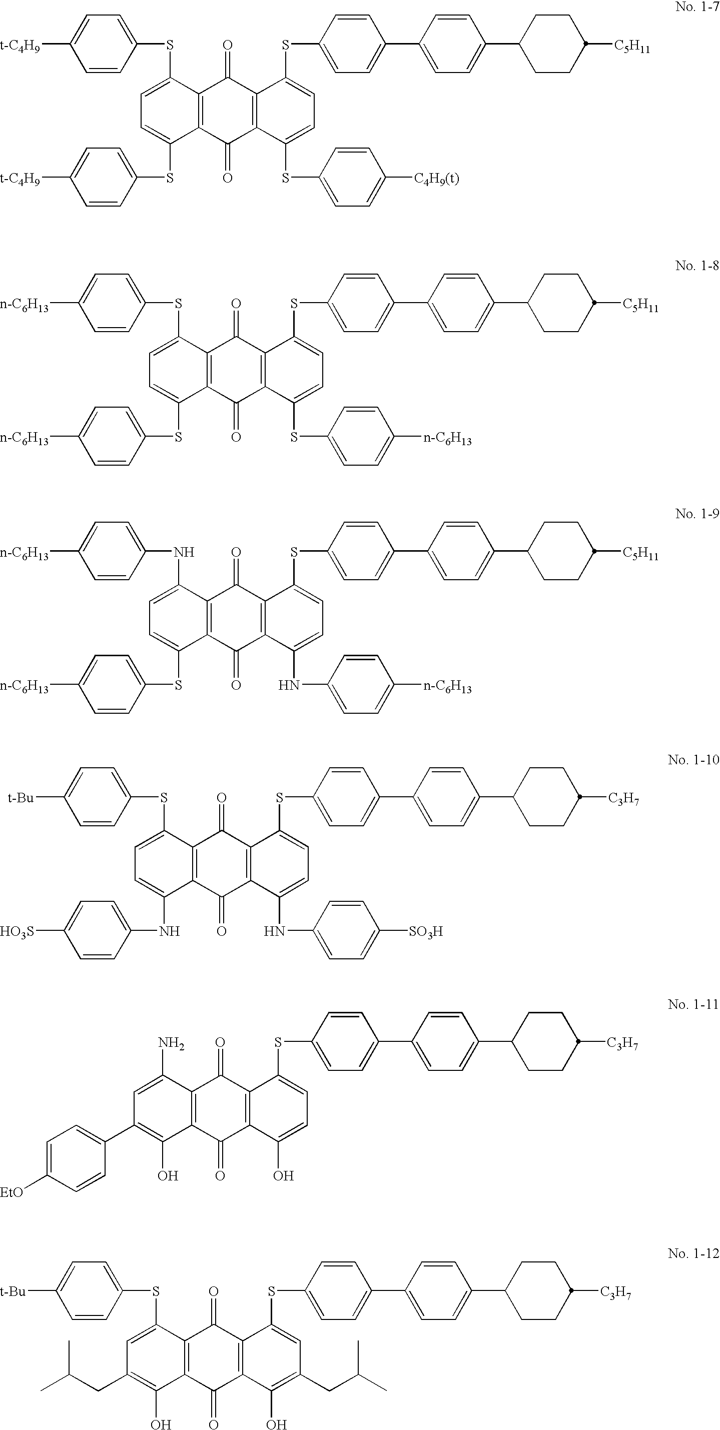

in the above structural formulas, Et represents an ethyl group, and t-Bu represents a tertiary butyl group.

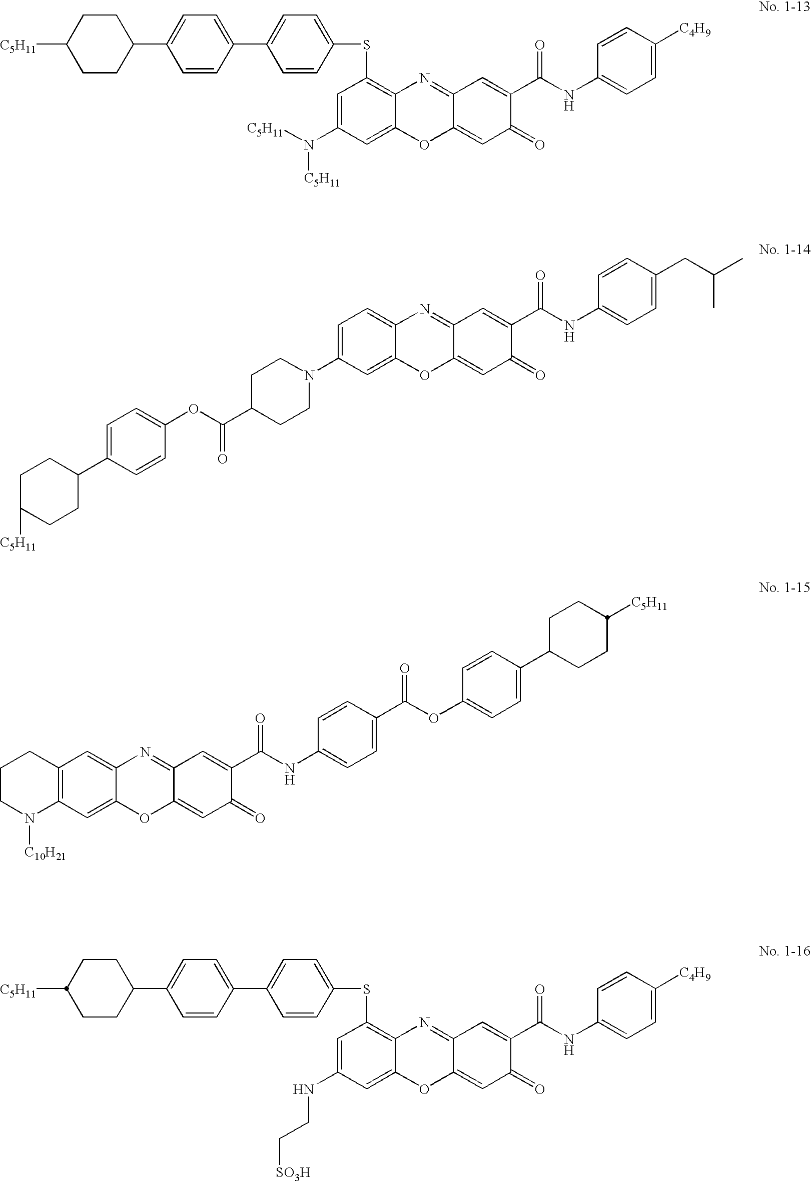

Specific examples of azo dichroic dyes which can be used in the present invention are as follows, but not limited thereto.

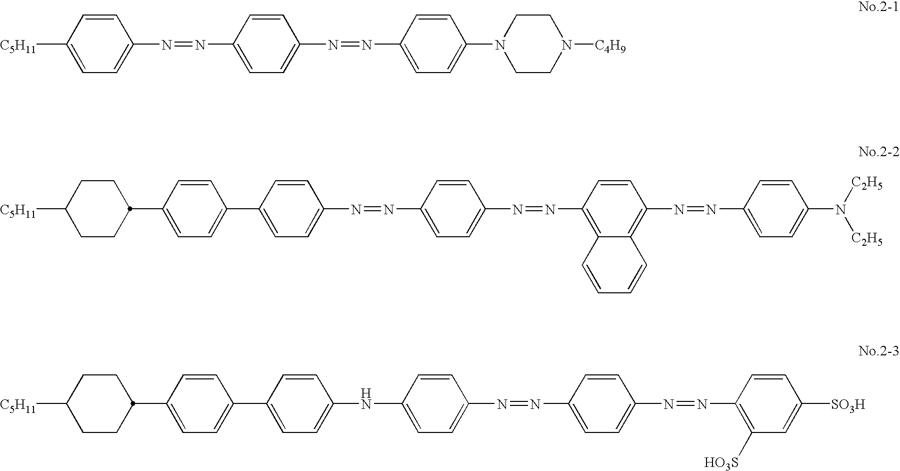

Specific examples of dioxazine dichroic dyes and merocyanine dichroic dyes which can be used in the present invention are as follows, but not limited thereto.

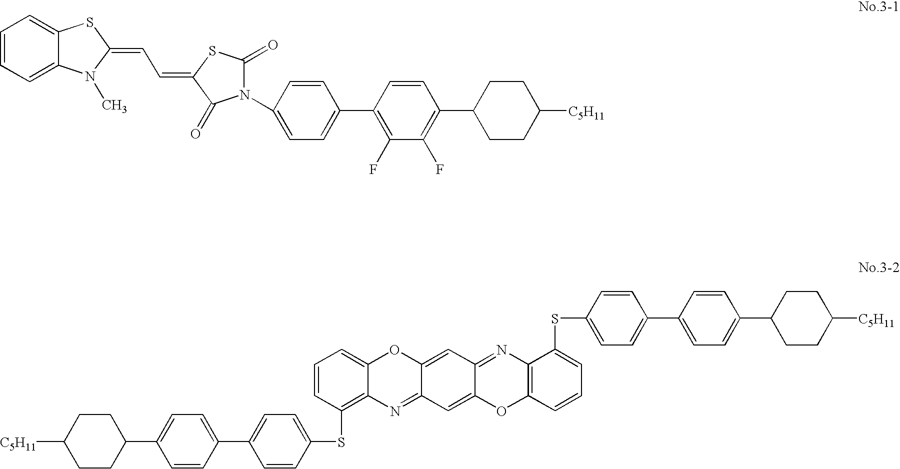

A dichroic dye having a substituent represented by General Formula (1) can be synthesized by a combination of known methods, for example, can be synthesized by the method described in Japanese Patent Application Laid-Open (JP-A) No. 2003-192664.

### —Anisotropic Metal Nanoparticle—

An anisotropic metal nanoparticle is a rod-like metal fine particle in nano size of several nano-meters to 100 nm. The rod-like metal fine particle means a particle having an aspect ratio (major axis length/minor axis length) of 1.5 or more.

Such an anisotropic metal nanoparticle exhibits surface plasmon resonance and exhibits absorption at ultraviolet wavelength region to infrared wavelength region. For example, an anisotropic metal nanoparticle having a minor axis length of 1 nm to 50 nm, a major axis length of 10 nm to 1,000 nm and an aspect ratio of 1.5 or more allows for changing the absorption position thereof between the minor axis direction and the major axis direction, and thus a polarizing film in which such an anisotropic metal nanoparticles are oriented in an oblique direction to the horizontal surface of the film is an anisotropically absorbing film.

FIG. 3 shows an absorption spectrum of an anisotropic metal nanoparticle having a minor axis length of 12.4 nm and a major axis length of 45.5 nm. Absorption of the minor axis of such an anisotropic metal nanoparticle resides near a wavelength of 530 nm and is red shifted. Absorption of the major axis of the anisotropic metal nanoparticle resides near a wavelength of 780 nm and is blue shifted.

Examples of metals for the anisotropic metal nanoparticles include gold, silver, copper, platinum, palladium, rhodium, osmium, ruthenium, iridium, iron, tin, zinc, cobalt, nickel, chrome, titanium, tantalum, tungsten, indium, aluminum and alloys thereof. Of these, gold, silver, copper and aluminum are preferable, and gold and silver are particularly preferable.

Next, as a preferred example of the anisotropic metal nanoparticle, a gold nanorod will be explained.

### —Gold Nanorod—

Production method of a gold nanorod is not particularly limited and may be suitably selected in accordance with the intended use, and (1) an electrolytic method, (2) a chemical reduction method and (3) a photoreduction method are exemplified.

In the (1) electrolytic method [Y.-Y. Yu, S.-S. Chang, C.-L. Lee, C. R. C. Wang, J. Phys. Chem. B, 101,6661 (1997)], an aqueous solution containing a cationic surfactant is electrolyzed by passing a constant electric current through it, and a gold cluster is eluted from an anodic metal plate to generate a gold nanorod. For the surfactant, a tetra ammonium salt having a structure in which four hydrophobic substituents are bound to a nitrogen atom is used, and a compound that does not form autonomous molecular aggregate such as tetradodecyl ammonium bromide (TDAB) is further added thereto. When a gold nanorod is produced, the supply source of gold is a gold cluster eluted from an anodic gold plate, and no gold salt such as chlorauric acid is used. During electrolyzation, an anodic gold plate is irradiated with an ultrasonic wave, and a silver plate is immersed in the solution to accelerate the growth of the gold nanorod.

In the electrolytic method, the length of a gold nanorod to be produced can be controlled by changing the area of a silver plate to be immersed, separately from electrodes to be used. By controlling the length of a gold nanorod, the position of an absorption band of near-infrared light region can be set in between around 700 nm to around 1,200 nm. When reaction conditions are kept constant, a gold nanorod formed in a certain shape can be produced. However, because a surfactant solution to be used in electrolyzation is a complicated system containing an excess amount of tetra ammonium salt, cyclohexane and acetone and there is an indefinite element such as irradiation of an ultrasonic wave, it is difficult to theoretically analyze a cause-effect relationship between the shape of gold nanorod to be produced and various preparation conditions and to optimize the preparation conditions of gold nanorod. Further, in terms of electrolyzation characteristics, it is not easy to intrinsically scale up, and thus electrolytic method is not suited for preparation of a large amount of gold nanorod.

In the (2) chemical reduction method [N. R. Jana, L. Gearheart, C. J. Murphy, J. Phys. Chem. B, 105,4065 (2001)], a chlorauric acid is reduced using NaBH₄ to generate a gold nanoparticle. The gold nanoparticle is used as a “seed particle” and the “seed particle” is made grow up in a solution to thereby obtain a gold nanorod. The length of the gold nanorod to be produced is determined depending on the quantitative ratio between the “seed particle” and the chlorauric acid to be added to a grown-up solution. The chemical reduction method allows for preparing a gold nanorod having a longer length than that produced by the (1) electrolytic method, and there has been reported a gold nanorod having a length longer than 1,200 nm and an absorption peak in near-infrared light region.

However, the chemical reduction method needs to prepare a “seed particle” and two reaction tanks and to subject it to a growth reaction. Generation of a “seed particle” ends in several minutes, however, it is difficult to increase the concentration of the gold nanorod to be produced. The concentration of generated gold nanorod is one-tenth or less of the concentration of a gold nanorod generated by the (1) electrolytic method.

In the (3) photoreduction method [F. kim, J. H. Song, P. Yang, J. Am. Chem. Soc., 124, 14316 (2002)], a chlorauric acid is added to the substantially same solution as used in the (1) electrolytic method, and the chlorauric acid is reduced by irradiation of ultraviolet ray. For the ultraviolet ray irradiation, a low-pressure mercury lamp is used. The photoreduction method allows for generating a gold nanorod without generating a seed particle, and for controlling the length of the gold nanorod by irradiation time of the ultraviolet ray, and has a characteristic in that the shape of the gold nanorod to be produced is uniformized. Further, the (1) electrolytic method needs fractionation of particles by centrifugal separation because a large amount of spherically shaped particles coexist after reaction, however, the photoreduction method needs no fractionation treatment because the method causes less amount of spherically shaped particles. The photoreduction method is excellent in reproducibility and enables to substantially surely obtain gold nanorods in same size by constant operation.

### —Carbon Nanotube—

The carbon nanotube is an elongated tubular carbon of 1 nm to 1,000 nm in fiber diameter, 0.1 μm to 1,000 μm in length, and 100 to 10,000 in aspect ratio.

For the production method of the carbon nanotube, for example, there are an arc discharge method, laser evaporation method, heat CVD method, and plasma CVD method known in the art. Carbon nanotubes obtained by an arc discharge method or laser evaporation method are classified into a single-layer carbon nanotube (SWNT: Single-Wall Nanotube) formed from only one-layer of graphene sheet and a multi-layered carbon nanotube (MWNT: Maluti-Wall Nanotube) formed from a plurality of graphene sheets.

Moreover, in the heat CVD method or the plasma CVD method, mainly a multi-wall nanotube can be produced. The single-wall nanotube has a structure in which one graphene sheet is wrapped around a material in which carbon atoms are bound to each other in a hexagonal shape by the strongest bond called an SP2 bond.

The carbon nanotube (SWNT, MWNT) is a tubular material of 0.4 nm to 10 nm in diameter and 0.1 μm to several hundred micro meters in length, having a structure that one graphene sheet is or several graphene sheets are rolled in a cylindrical shape. It has a unique characteristic in that it becomes a metal or a semiconductor depending on in which direction the graphene sheet(s) are rolled. Such a carbon nanotube has characteristics that light absorption and emission easily occurs in the longitudinal direction thereof but rarely occurs in the radial direction thereof, and can be used as an anisotropically absorbing material and an anisotropic scattering material.

The amount of the polarizer in the polarizing film is preferably 0.1% by mass to 90.0% by mass and more preferably 1.0% by mass to 30.0% by mass. When the amount is more than 0.1% by mass, sufficient polarization performance can be obtained. On the other hand, when the amount of the polarizer in the polarizing film is 90.0% by mass or less, a polarizing film can be deposited with no difficulty, and the transmittance of the polarizing film can be maintained.

The vertically polarizing film contains the polarizer, and further contains other components such as a dispersing agent, a solvent and a binder resin, depending on the method of forming a polarizing film (orientation method).

### <Production Method of Vertically Polarizing Film>

The production method of a vertically polarizing film is not particularly limited as long as an absorption axis of a polarizer can be oriented in a substantially vertical direction to the base surface (horizontal surface), and may be suitably selected in accordance with the intended use. Examples of the production method include (1) a method of depositing metal nanorods in a liquid crystal orientation region, (2) a guest-host liquid crystal method and (3) an anodic oxidation alumina method. Of these, a guest-host liquid crystal method is particularly preferable.

The (1) method of depositing metal nanorods in a liquid crystal orientation region includes a liquid crystal film forming step, impregnating step, reducing step, and further include other steps as necessary.

The liquid crystal film forming step is a step of forming a liquid crystal film by applying a liquid crystal composition containing at least a liquid crystal compound on a base having an orientation film on a surface thereof, and then curing the composition to immobilize molecules of the liquid crystal compound in a substantially vertically oriented state.

In the liquid crystal film forming step, a resin composition which contains at least the liquid crystal compound and solvent, and further contains an orientation agent as necessary, is applied on the base and dried to deposit a liquid crystal film.

### —Base—

The base is not particularly limited as to the shape, structure, size and the like, and may be suitably selected in accordance with the intended use. Examples of the shapes of the base include a plate and a sheet. The base may be formed in a single-layer structure or a multi-layered structure and the structure can be suitably selected.

A material used for the base is not particularly limited, and both inorganic materials and organic materials can be suitably used.

Examples of the inorganic materials include glass, quartz and silicon. Examples of the organic materials include acetate resins such as triacetylcellulose (TAC); polyester resins, polyether sulfone resins, polysulfone resins, polycarbonate resins, polyamide resins, polyimide resins, polyolefin resins, acrylate resins, polynorbornene resins, cellulose resins, polyarylate resins, polystyrene resins, polyvinyl alcohol resins, polyvinyl chloride resins, polyvinylidene chloride resins, and polyacrylate resins. These materials may be used alone or in combination.

As the base, a suitably synthesized base or a commercially available product may be used.

The thickness of the base is not particularly limited and may be suitably selected in accordance with the intended use, it is preferably 10 μm to 500 μm and more preferably 50 μm to 300 μm.

### —Orientation Film—

The orientation film is formed by depositing a film of polyimide, polyamideimide, polyetherimide, polyvinyl alcohol or the like on the base surface.

The orientation film may be a film subjected to a photo-orientation treatment. In the photo-orientation, an anisotropy is generated on a surface of a photo-orientation film by irradiating photoactive molecules such as an azobenzene polymer, polyvinyl cinnamate or the like with a linearly polarized light or unpolarized light at a wavelength for causing a photochemical reaction, by effect of incident light an orientation of molecular major axis is generated in the outermost surface of the film, and a driving force is formed therein so as to orient a liquid crystal contacting with molecules in the outermost surface.

Examples of materials of the photo-orientation film include the above-mentioned materials, and further include materials capable of generating an anisotropy on a film surface by any one of reactions of photoisomerization, photodimerization, photocyclization, photocrosslinking, photodegradation, and photodegradation-bonding by irradiation of a linearly polarized light at a wavelength for causing a photochemical reaction of photoactive molecules. For example, it is possible to use various photo-orientation film materials described in “Journal of the Liquid Crystal Society of Japan, Vol. 3 No. 1, p. 3 (1999), by Masaki Hasegawa”, “Journal of the Liquid Crystal Society of Japan, Vol. 3 No. 4, p. 262 (1999)” by Yasumasa Takeuchi” and the like.

When a liquid crystal is applied over the surface of an orientation film described above, the liquid crystal is oriented by using at least any of fine grooves on the orientation film surface and orientation of molecules in the outermost surface as a driving force.

The ultraviolet curable liquid crystal compound is not particularly limited as long as it has a polymerizable group and can be hardened by irradiation of ultraviolet ray, and may be suitably selected in accordance with the intended use. For example, compounds represented by any one of the following structural formulas are preferably exemplified.

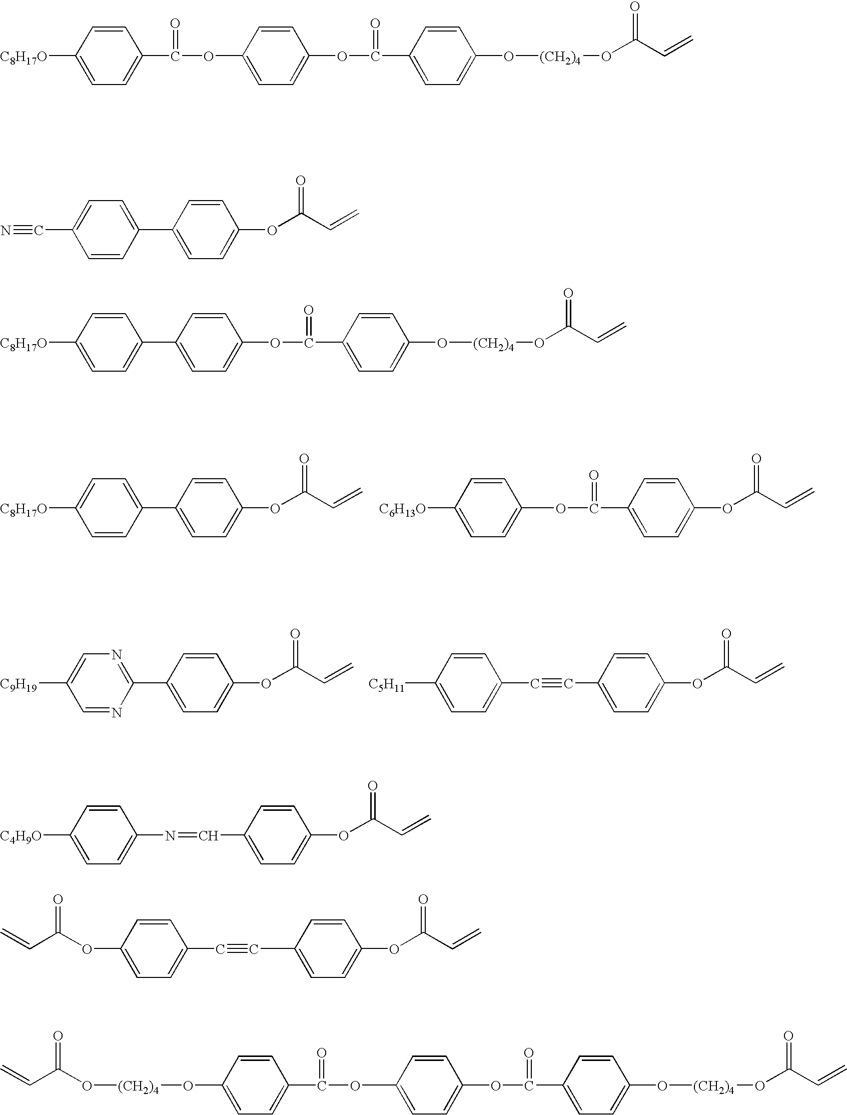

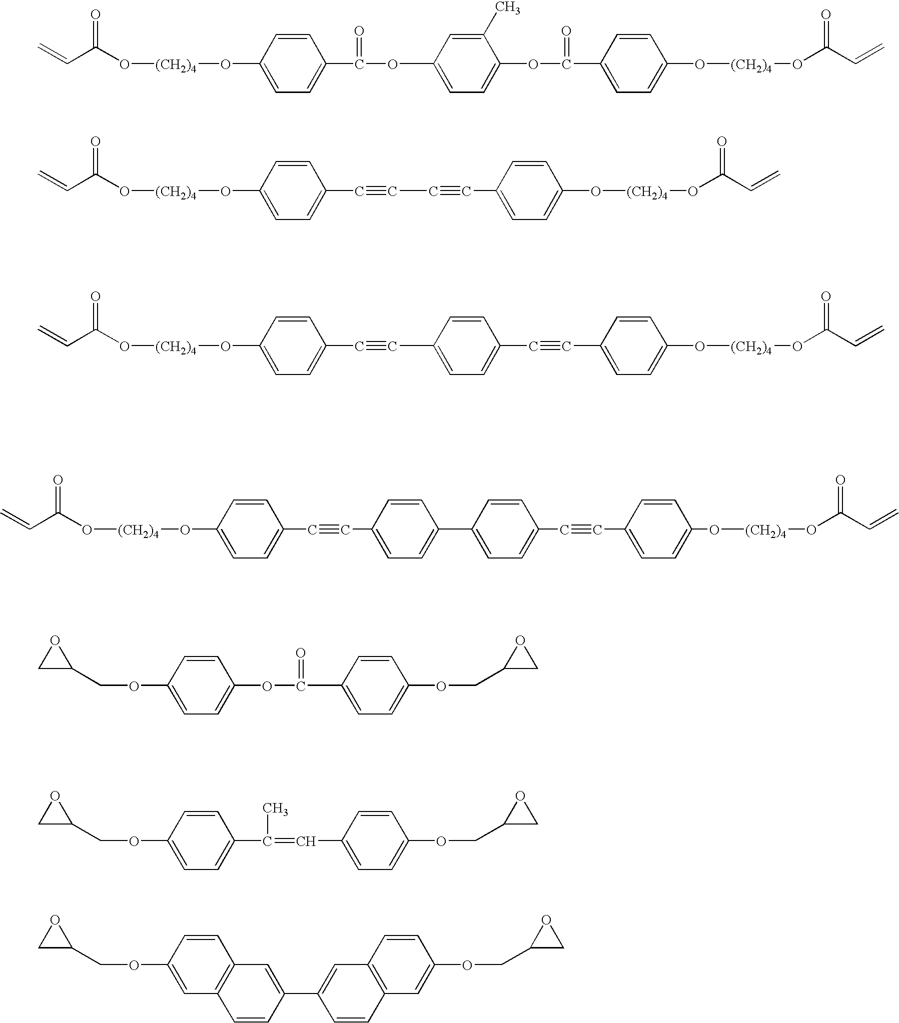

For the liquid crystal compound, commercially available products can be used. Examples of the commercially available products include PALIOCOLOR LC242 manufactured by BASF; E7 manufactured by Merck Ltd.; LC-SILICON-CC3767 manufactured by Wacker-Chemie; and L35, L42, L55, L59, L63, L79 and L83 manufactured by Takasago International Corporation.

The amount of the liquid crystal compound is preferably 10% by mass to 90% by mass and more preferably 20% by mass to 80% by mass relative to the total solid content of a coating solution for the polarizing film.

### —Air-Interface Vertical Orientation Agent—

A vertically polarizing film is characterized in that the absorption axis of a polarizer is substantially vertically oriented to a base surface. To this end, a liquid crystal layer serving as a medium must be oriented in a substantially vertical direction to the base surface. In some cases, a liquid crystal layer formed on an orientation film that has been formed on one surface of the base is substantially vertically oriented from the orientation film side through to the air interface side by controlling the ends thereof so as to be hydrophobic, however, the orientation may be obliquely shifted in the air interface if left as it is. Thus, the absorption axis of the polarizer is stably vertically oriented to the base surface by adding the air-interface vertical orientation agent.

Such an air-interface vertical orientation agent is not particularly limited and may be suitably selected in accordance with the intended use. Examples thereof include the compounds described in paragraph Nos. [0110] to [0194] in Japanese Patent Application Laid-Open (JP-A) No. 2006-301605.

A polymer surfactant having a strong mutual interaction with a liquid crystal layer to be used may be selected from commercially available polymer surfactants; for example, MEGAFAC F780F (manufactured by Dainippon Ink and Chemicals, Inc.) is preferably used.

The amount of the air-interface vertical orientation agent is preferably 0.01% by mass to 5.0% by mass and more preferably 0.05% by mass to 3.0% by mass relative to the total solid content of the coating solution for polarizing film.

### —Photopolymerization Initiator—

The coating solution for polarizing film preferably contains a photopolymerization initiator. The photopolymerization initiator is not particularly limited and may be suitably selected from conventional photopolymerization initiators in accordance with the intended use. Examples thereof include p-methoxyphenyl-2,4-bis(trichloromethyl)-s-triazine, 2-(p-butoxystyryl)-5-trichloromethyl 1,3,4-oxadiazole, 9-phenylacrydine, 9,10-dimethylbenzphenazine, benzophenone/Michler's ketone, hexaarylbiimidazole/mercaptobenzimidazole, benzyldimethyl ketal, and thioxanthone/amine. These photopolymerization initiators may be used alone or in combination.

For the photopolymerization initiator, commercially available products can be used. Examples thereof include IRGACURE 907, IRGACURE 369, IRGACURE 784 and IRGACURE 814 manufactured by Chiba Specialty Chemicals K.K.; and LUCIRIN TPO manufactured by BASF.

The amount of the photopolymerization initiator is preferably 0.1% by mass to 20% by mass and more preferably 0.5% by mass to 5% by mass relative to the total solid content mass of the coating solution for polarizing film.

The solvent is not particularly limited and may be suitably selected in accordance with the intended use. Examples thereof include halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, methoxybenzene, and 1,2-dimethoxybenzene; ketone solvents such as acetone, methyl ethyl ketone (MEK), methyl isobutyl ketone, cyclohexanone, cyclopentanone, 2-pyrrolidone, and N-methyl-2-pyrrolidone; ester solvents such as ethyl acetate and butyl acetate; alcohol solvents such as t-butyl alcohol, glycerine, ethylene glycol, triethylene glycol, ethylene glycol monomethylether, diethylene glycol dimethylether, propylene glycol, dipropylene glycol, and 2-methyl-2,4-pentandiol; amide solvents such as dimethyl formamide and dimethylacetoamide; nitrile solvents such as acetonitrile and butylonitrile; ether solvents such as diethyl ether, dibutyl ether, tetrahydrofuran, and dioxane; and carbon disulfide, ethyl cellosolve and butyl cellosolve. These solvents may be used alone or in combination.

Examples of the coating methods include a spin-coating method, casting method, roller coating method, flow coating method, printing method, dip coating method, flow casting method, bar coating method and gravure coating method.

The curing may be thermal curing or photocuring, and photocuring is particularly preferable.

Examples of the impregnating methods include (1) a method of immersing a liquid crystal film in a solution containing at least a metal ion, and (2) a method of applying a solution containing at least a metal ion onto a liquid crystal film surface. Additionally, it is preferable that the liquid crystal film be swollen beforehand in the solution when the immersion or the application is carried out.

The reducing step is a step of reducing a metal ion in a liquid crystal film to form anisotropic metal nanoparticles.

It is preferable that the metal ion be at least one selected from ions of silver, gold, copper, aluminum, palladium, rhodium, platinum, ruthenium, selenium, tellurium, cobalt and nickel. Of these, ions of gold, silver, copper and aluminum are particularly preferable.

For a metal ion source in the metal ion, a metal compound is preferable, for example.

Examples of the metal compound include a metal salt, a metal complex and an organic metal compound.

An acid for forming a metal salt may be any one of an inorganic acid and an organic acid.

The inorganic acid is not particularly limited and may be suitably selected in accordance with the intended use. Examples thereof include nitric acid, and halogenated hydroacids such as hydrochloric acid, hydrobromic acid and hydriodic acid.

The organic acid is not particularly limited and may be suitably selected in accordance with the intended use. Examples thereof include a carboxylic acid and a sulfonic acid.

Examples of the carboxylic acids include acetic acid, butyric acid, oxalic acid, stearic acid, behenic acid, lauric acid and benzoic acid.

Examples of the sulfonic acids include methylsulfonic acid.

A chelating agent for forming a metal complex is not particularly limited and may be suitably selected in accordance with the intended use. Examples thereof include acetylacetonate and EDTA. Also, a complex may be formed by a metal salt and a ligand. Examples of the ligands include imidazole, pyridine and phenylmethyl sulfide.

Examples of metal compounds also include acids of halogenated complexes of metal ions (for example, chloroauric acid and chloroplatinic acid), and alkali metal salts (for example, sodium chloroaurate and sodium tetrachloropalladate).

The reduction is at least one of photoreduction, thermal reduction and chemical reduction and can be a combination thereof. Of these, photoreduction is particularly preferable.

Examples of lights for use in the photoreduction include visible light, ultraviolet light, near-infrared light, X-ray and electron beam. Of these, ultraviolet light is particularly preferable.

A condition of the ultraviolet irradiation is not particularly limited and may be suitably selected in accordance with the intended use; for example, the wavelength of an ultraviolet light applied is preferably 160 nm to 380 nm, and more preferably 250 nm to 380 nm, the irradiation energy is 1 mW/cm² to 10,000 mW/cm² and the irradiation time is 1 sec to 600 min.

Examples of light sources of the ultraviolet light include low-pressure mercury vapor lamps (for example, a bactericidal lamp, fluorescent chemical lamp and black light), high-pressure discharge lamps (for example, a high-pressure mercury vapor lamp and metal halide lamp) and short-arc discharge lamps (for example, an extra-high-pressure mercury vapor lamp, xenon lamp and mercury xenon lamp).

Additionally, a light applied may be a polarized light. The polarized light is preferably a linearly polarized light.

The polarized light is applied in accordance with a conventional method, for example, a method of using the light source and a polarizing plate of iodine, dichroic dye, a wire grid, etc., a method of using a polarizing transmission filter utilizing Brewster's angle, a method of using a Glan-Thompson prism, a method of using a laser light having polarizing properties or the like.

When metal ions are reduced in the reducing step, anisotropic metal nanoparticles whose absorption axis orients in a substantially vertical direction of the liquid crystal molecules of the liquid crystal matrix are deposited.

The (2) guest-host liquid crystal method is a method of forming a polarizing film in which a coating solution for polarizing film containing an ultraviolet curable liquid crystal compound and a polarizer (a dichroic dye, anisotropic metal nanoparticles and the like), and further containing an air-interface vertical orientation agent as necessary, is applied over a base having an orientation film on the surface thereof, the applied surface is dried to form a coating layer and the coating layer is irradiated with ultraviolet ray in a state where the coating layer is heated to a temperature at which a liquid crystal phase occurs to thereby form a polarizing film in which the absorption axis of the polarizer is oriented in a substantially vertical direction to the base surface.

As the base, orientation film, liquid crystal compound and orientation agent, the same as those in the (1) method of depositing metal nanorods in a liquid crystal orientation region can be used.

The (3) anodic oxidation alumina method is a method of forming a polarizing film in which aluminum is deposited on a base having a conductive film on the surface thereof to form an aluminum deposition layer, the aluminum deposition layer is anodized to form nanoholes thereon, a metal is electroformed in the nanoholes to form a metal nanorod having an aspect ratio of 1.5 or more to thereby form a polarizing film in which the absorption axis of the metal nanorod is substantially vertically oriented to the base surface.

The thickness of the vertically polarizing film is not particularly limited and may be suitably selected in accordance with the intended use, and it is preferably 0.1 μm to 10 μm and more preferably 0.3 μm to 3 μm.

### <π/2 Optical Rotation Film>

A π/2 optical rotation film contains an optical rotator which rotates a vibration direction of linearly polarized light by substantially 90 degrees, and further contains other components as necessary.

In the optical rotator, “substantially 90 degrees” means 90 degrees±10 degrees.

The π/2 optical rotation film is not particularly limited and may be suitably selected in accordance with the intended use. A twisted nematic liquid crystal cell is a typical π/2 optical rotation film. The twisted nematic liquid crystal cell is formed by sandwiching a nematic liquid crystal in between glass substrates having orientation films which have been subjected to rubbing treatment in a mutually orthogonal direction so as to produce a layer of twisted nematic liquid crystal having a thickness of 2 μm to 10 μm, in which a liquid crystal orientation direction is gradually twisted in a thickness direction from the bottom surface to the upper surface. This can be used as an optical rotation film, but the nematic liquid crystal cell having glass substrates sandwiching the nematic liquid crystal is limited in increase of area and lacks of flexibility.

Consequently, in order to make the twisted nematic liquid crystal film flexible and larger, a chiral agent is added to a UV curable liquid crystal, and applied on a base film containing an orientation film which has been subjected to rubbing treatment. At this time, the amount of the chiral agent and the thickness of a liquid crystal layer are necessary to be adjusted to preferably within ±5%, and more preferably within ±2% of their reference values, with high accuracy.

### —Chiral Agent—

Chiral agent is not particularly limited and may be suitably selected from those known in the art in accordance with the intended use. Examples thereof include an isomannide compound, catechin compound, isosorbide compound, fenchone compound and carvone compound, and additionally, compounds expressed below. These may be used alone or in combination.

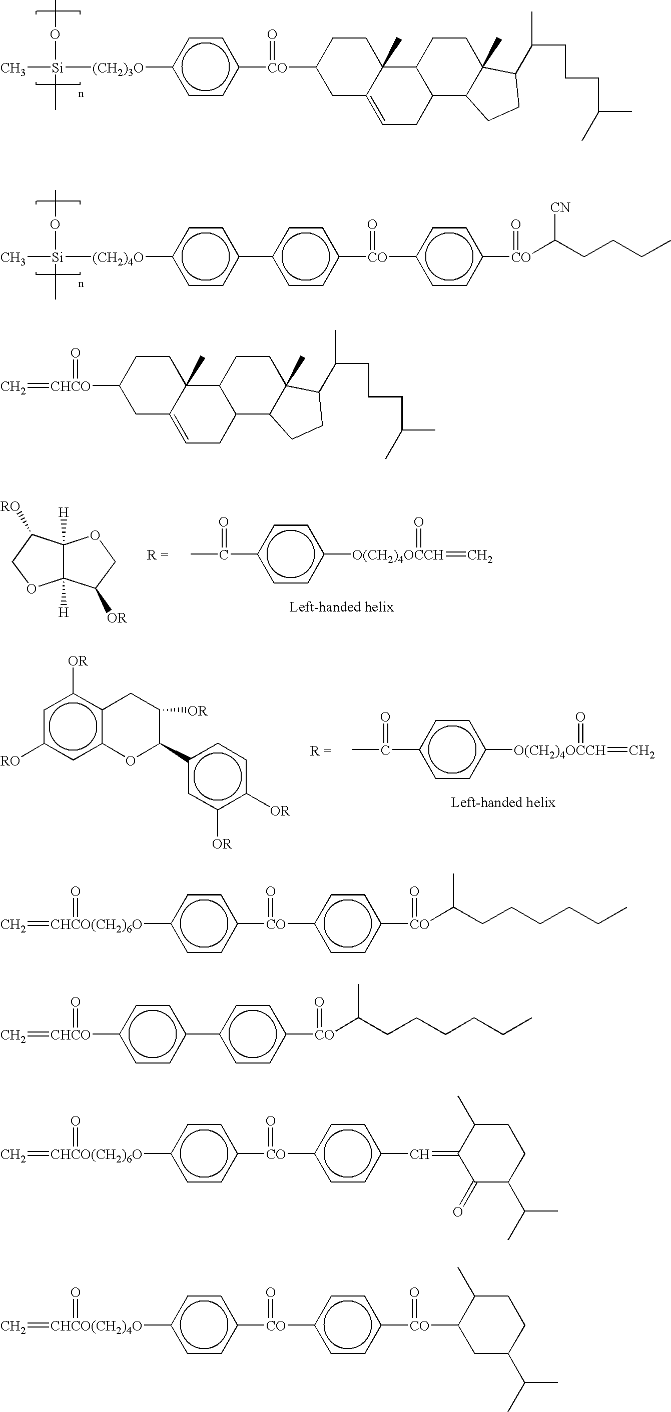

As the chiral agent, commercially available products can be used, and examples thereof include S101, R811 and CB15 manufactured by Merck, and PALIOCOLOR LC745 and LC756 manufactured by BASF.

The amount of the chiral agent is preferably 30% by mass or less and more preferably 20% by mass or less relative to the amount of total solids of the coating solution for π/2 optical rotation film.

The thickness of the π/2 optical rotation film is not particularly limited and may be suitably selected in accordance with the intended use, and it is preferably 0.3 μm to 100 μm and more preferably 0.5 μm to 30 μm.

### —Lamination Method—

A method for laminating the vertically polarizing film and the π/2 optical rotation film is not particularly limited and may be suitably selected in accordance with the intended use. Examples thereof include: (1) a method in which the vertically polarizing film and the π/2 optical rotation film are independently prepared and then bonded together by an adhesive sheet or the like; (2) a method of producing an optical film, in which a coating solution for π/2 optical rotation film is applied on the vertically polarizing film and dried to form the π/2 optical rotation film; (3) a method of producing an optical film, in which a coating solution for vertically polarizing film is applied on the π/2 optical rotation film, and dried to form the vertically polarizing film; (4) a method in which the π/2 optical rotation films are bonded to both surfaces of the vertically polarizing film via adhesive sheets and the like; and (5) a method in which a coating solution for π/2 optical rotation film is applied on both surfaces of the vertically polarizing film, and dried to form the π/2 optical rotation films.

### <Antireflection Film>

In the optical film of the present invention, when the glass of the present invention is placed so that sunlight is incident from one surface of the base, the glass preferably has an antireflection film at least on the outermost surface of the base on which sunlight is not incident. When the glass of the present invention is used as a building glass or windshield of vehicle, it is more preferable that the glass have the optical film on a surface of the base on which sunlight is not incident (or the internal surface of the vehicle) and has an antireflection film on the optical film.

The antireflection film is not particularly limited as long as it has sufficient durability and heat resistance in practical use and is capable of suppressing the reflectance to 5% or less at an incident angle of 60 degrees, and may be suitably selected in accordance with the intended use. Examples thereof include (1) a film having fine convexoconcaves formed on the surface thereof, (2) a two-layered film structure using a combination of a film having a high refractive index and a film having a low refractive index, and (3) a three-layered film structure in which a film having a high refractive index, a film having a medium refractive index and a film having a low refractive index are sequentially formed in a laminate structure. Of these, the film (2) and the film (3) are particularly preferable.

Each of these antireflection films may be directly formed on a base surface by a sol-gel method, sputtering method, deposition method, CVD method or the like. Further, each of these antireflection films may be formed by forming an antireflection film on a transparent support by a dip coating method, air-knife coating method, curtain coating method, roller coating method, wire bar coating method, gravure coating method, micro-gravure coating method or extrusion coating method and making the formed antireflection film adhered on or bonded to the base surface.

The antireflection film preferably has a layer structure in which at least one layer having a higher refractive index than that of a low-refractive index layer (a high-refractive index layer) and the low-refractive index layer (the outermost surface layer) are formed in this order on a transparent support. When two layers of refractive index layers each having a higher refractive index than that of the low-refractive index layer are formed, a layer structure is preferable in which a medium refractive index layer, a high-refractive index layer and a low-refractive index layer (the outermost surface layer) are formed in this order on a transparent support. An antireflection film having such a layer structure is designed so as to have refractive indexes satisfying the relation of “a refractive index of a high-refractive index layer>a refractive index of a medium refractive index layer>a refractive index of a transparent support>a refractive index of a low-refractive index layer”. Note that the respective refractive indexes are relative indexes.

### —Transparent Support—

For the transparent support, it is preferable to use a plastic film. Examples of materials of the plastic film include cellulose acylates, polyamides, polycarbonates, polyesters (for example, polyethylene terephthalate, polyethylene naphthalate, etc.), polystyrenes, polyolefins, polysulfones, polyether sulfones, polyarylates, polyetherimides, polymethyl methacrylates, and polyether ketones.

### —High-Refractive Index Layer and Medium Refractive Index Layer—

The layer having a high-refractive index in the antireflection layer is preferably composed of a curable film containing inorganic fine particles having a high-refractive index and an average particle diameter of 100 nm or less, and a matrix binder.

The inorganic fine particle having a high-refractive index is an inorganic compound having a refractive index of 1.65 or more, and preferably an inorganic compound having a refractive index of 1.9 or more. Examples thereof include oxides of Ti, Zn, Sb, Sn, Zr, Ce, Ta, La, In and Al; and composite oxides containing these metal atoms. Of these, an inorganic fine particle which contains mainly titanium dioxide and at least one element selected from Co, Zr and Al (hereinafter, may be referred to as “specific oxide”) is preferable, and a particularly preferable element is Co.

The total amount of Co, Al and Zr to the amount of Ti is 0.05% by mass to 30% by mass, preferably 0.1% by mass to 10% by mass, more preferably 0.2% by mass to 7% by mass, still more preferably 0.3% by mass to 5% by mass, and particularly preferably 0.5% by mass to 3% by mass.

Co, Al and Zr exist inside or on the surface of the inorganic fine particle mainly containing titanium dioxide. It is more preferable that Co, Al and Zr exist inside the inorganic fine particle mainly containing titanium dioxide, and it is still more preferable that Co, Al and Zr exist inside and on the surface of the inorganic fine particle mainly containing titanium dioxide. These specific metal elements may exist as oxides.

Further, another preferable inorganic fine particle is, for example, an inorganic fine particle which is a particle of a composite oxide composed of a titanium element and at least one metal element (hereinafter, occasionally abbreviated as “Met”) selected from metal elements that will have a refractive index of 1.95 or more, and the composite oxide is doped with at least one metal ion selected from Co ion, Zr ion and Al ion (hereinafter, may be referred to as “specific composite oxide”).

Here, examples of the metal elements of the metal oxide that will have a refractive index of 1.95 or more in the composite oxide include Ta, Zr, In, Nd, Sb, Sn and Bi. Of these, Ta, Zr, Sn and Bi are particularly preferable.

The amount of the metal ion doped into the composite oxide is preferably contained in a range not exceeding 25% by mass, more preferably 0.05% by mass to 10% by mass, still more preferably 0.1% by mass to 5% by mass, and particularly preferably 0.3% by mass to 3% by mass in the total amount of the metal [Ti and Met] constituting the composite oxide, from the viewpoint of maintaining refractive indexes.

The doped metal ion may exist as any of a metal ion and a metal atom and preferably exists in an appropriate amount from the surface of the composite oxide through the inside thereof. It is more preferable that the doped metal ion exist on the surface of and inside the composite oxide.

Examples of methods of producing the fine particle as described above include a method of treating the particle surface with a surface treatment agent; a method of making a core shell structure in which a particle having a high-refractive index is used as the core, and a method of using a specific dispersing agent in combination.

Examples of the surface treatment agents used in the method of treating the particle surface therewith include the silane coupling agents described in JP-A Nos. 11-295503, 11-153703 and 2000-9908; and the anionic compounds or organic metal coupling agents described in JP-A No. 2001-310432.

For the method of making the core shell structure using a high-refractive index particle as the core, the techniques described in JP-A Nos. 2001-166104 and U.S. Patent Application Publication No. 2003/0202137 can be used.

Further, examples of the methods of using a specific dispersing agent in combination include techniques described in Japanese Patent Application JP-A No. 11-153703, U.S. Pat. No. 6,210,858 and JP-A No. 2002-2776069.

Examples of materials used for forming a matrix include conventionally known thermoplastic resins and curable resin films.

Further, it is preferable to use at least one composition selected from a polyfunctional compound containing compositions in which two or more radically polymerizable and/or cationic polymerizable groups are contained, a hydrolyzable group containing organic metal compounds, and partially condensate compositions thereof. Examples of the compositions include the compounds described in JP-A Nos. 2000-47004, 2001-315242, 2001-31871 and 2001-296401.

Furthermore, colloidal metal oxides obtainable from hydrolyzed condensates of metal alkoxide and curable films obtainable from metal alkoxide compositions are also preferable. Examples thereof include the curable film described in Japanese Patent Application Laid-Open (JP-A) No. 2001-293818.

The refractive index of the high refractive index layer is preferably 1.70 to 2.20. The thickness of the high refractive index layer is preferably 5 nm to 10 μm and more preferably 10 nm to 1 μm.

The refractive index of the medium refractive index layer is controlled so as to be a value between the refractive index of the low refractive index layer and that of the high refractive index layer. The refractive index of the medium refractive index layer is preferably 1.50 to 1.70. The thickness of the medium refractive index layer is preferably 5 nm to 10 μm and more preferably 10 nm to 1 μm.

### —Low Refractive Index Layer—

The low refractive index layer is preferably laminated on the high refractive index layer. The refractive index of the low refractive index layer is preferably 1.20 to 1.55 and more preferably 1.30 to 1.50.

The low refractive index layer is preferably structured as the outermost surface layer to obtain abrasion resistance and antifouling performance. As a method of greatly increasing abrasion resistance, it is effective to impart slippage to the outermost surface, and a thin layer doped with a silicone compound or a fluorine-containing compound is preferably used.

The refractive index of the fluorine-containing compound is preferably 1.35 to 1.50 and more preferably 1.36 to 1.47. For the fluorine-containing compound, a compound containing fluorine atom in the range of 35% by mass to 80% by mass and containing a crosslinkable or polymerizable functional group is preferable.

Examples thereof include the compounds described in paragraph Nos. [0018] to [0026] in JP-A No. 9-222503, paragraph Nos. [0019] to [0030] in JP-A No. 11-38202, paragraph Nos. [0027] to [0028] in JP-A No. 2001-40284, and JP-A Nos. 2000-284102 and 2004-45462.

For the silicone compound, it is preferably a compound having a polysiloxane structure and containing a curable functional group or a polymerizable functional group in a high-molecular chain to have a crosslinked structure in a film. Examples thereof include reactive silicones, such as SYRAPLANE (manufactured by CHISSO CORPORATION) and polysiloxane containing a silanol group at both ends thereof (JP-A No. 11-258403).

The crosslinking reaction or polymerization reaction of a polymer containing fluorine and/or siloxane having a crosslinkable or polymerizable group is preferably carried out by irradiating with light and/or heating a coating composition used for forming the outermost surface layer containing a polymerization initiator, a sensitizer and the like, at the same time of the coating process or after the coating process. For the polymerization initiator and the sensitizer, those known in the art can be used.

Further, for the low-refractive index layer, a sol-gel cured film, which is cured by subjecting an organic metal compound such as a silane coupling agent and a silane coupling agent containing a specific fluorine-containing hydrocarbon group to a condensation reaction in co-presence of a catalyst, is preferable. Examples thereof include polyfluoroalkyl group-containing silane compounds or partially hydrolyzed condensates (such as the compounds described in JP-A Nos. 58-142958, 58-147483, 58-147484, 9-157582 and 11-106704); and silyl compounds containing a poly-perfluoroalkylether group that is a fluorine-containing long-chain group (such as the compounds described in JP-A Nos. 2000-117902, 2001-48590 and 2002-53804).

It is preferable that the low-refractive index layer contains a low-refractive index inorganic compound having an average primary particle diameter of 1 nm to 150 nm such as fillers (for example, silicon dioxide, silica; and fluorine-containing particles such as fluorinated magnesium, fluorinated calcium, and fluorinated barium) as additives other than those described above.

Particularly, it is preferable to use a hollow inorganic fine particle in the low-refractive index layer so as to further suppress the increase of refractive index. The refractive index of the hollow inorganic fine particle is preferably 1.17 to 1.40. The refractive index described here indicates a refractive index of an entire particle and does not indicate a refractive index of only the outer-shell forming the hollow inorganic fine particle.

The average particle diameter of the hollow inorganic fine particle in the low-refractive index layer is preferably 30% to 100%, more preferably 35% to 80%, and still more preferably 40% to 60% of the thickness of the low-refractive index layer.

Specifically, when the thickness of the low-refractive index layer is 100 nm, the particle diameter of the inorganic fine particle is preferably 30 nm to 100 nm, more preferably 35 nm to 80 nm, and still more preferably 40 nm to 60 nm.

The refractive index of the hollow inorganic fine particle can be measured in the following manner that the hollow inorganic fine particles are mixed in a suitable matrix polymer to form a film, and the refractive index of the film is measured using a prism coupler MODEL2010 (by METRICON CORPORATION).

For the other additives, the low-refractive index layer may contain the organic fine particles, silane coupling agents, lubricants, surfactants and the like described in paragraph Nos. [0020] to [0038] in JP-A No. 11-3820.

When the low-refractive index layer is positioned as an under layer of the outermost surface layer, the low-refractive index layer may be formed by a gas-phase method (for example, a vacuum evaporation method, sputtering method, ion-plating method, and plasma CVD method), however, it is preferably formed by a coating method, in terms of its cheap production cost.

The thickness of the low-refractive index layer is preferably 30 nm to 200 nm, more preferably 50 nm to 150 nm, and still more preferably 60 nm to 120 nm.

### (Glass)

The glass of the present invention contains at least a base and the optical film of the present invention, and further contains other components as necessary.

In this case, examples of the preferred configurations of the glass include a configuration when the glass is placed so that the sunlight is incident from one surface of the base, the optical film is located on the other surface of the base from which the sunlight is not incident (a base surface inside the vehicle), and a configuration that a base is a laminated glass in which an intermediate layer is sandwiched in between two plate glasses and the intermediate layer contains the optical film.

The glass of the present invention is preferably used for at least any of a windshield and a side window glass of a vehicle.

In a windshield of a vehicle, an angle formed by a base surface and horizontal reference plane is preferably 20 degrees to 50 degrees.

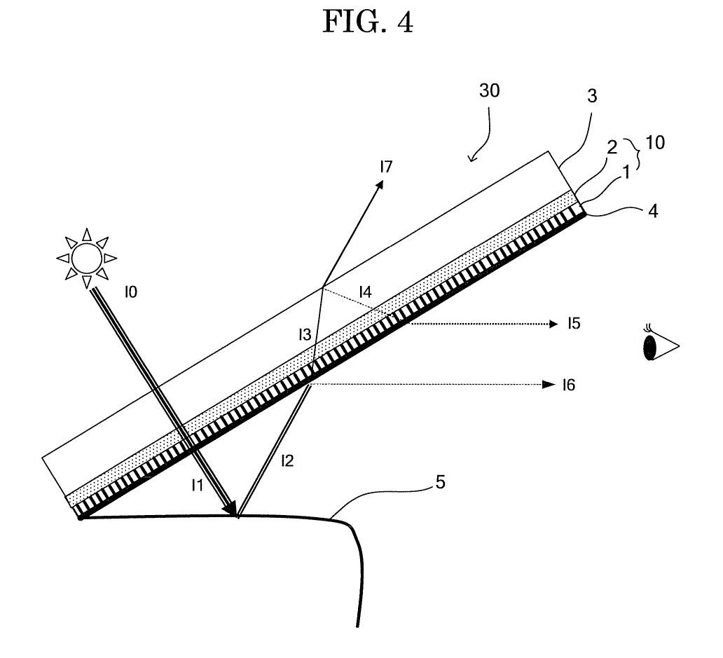

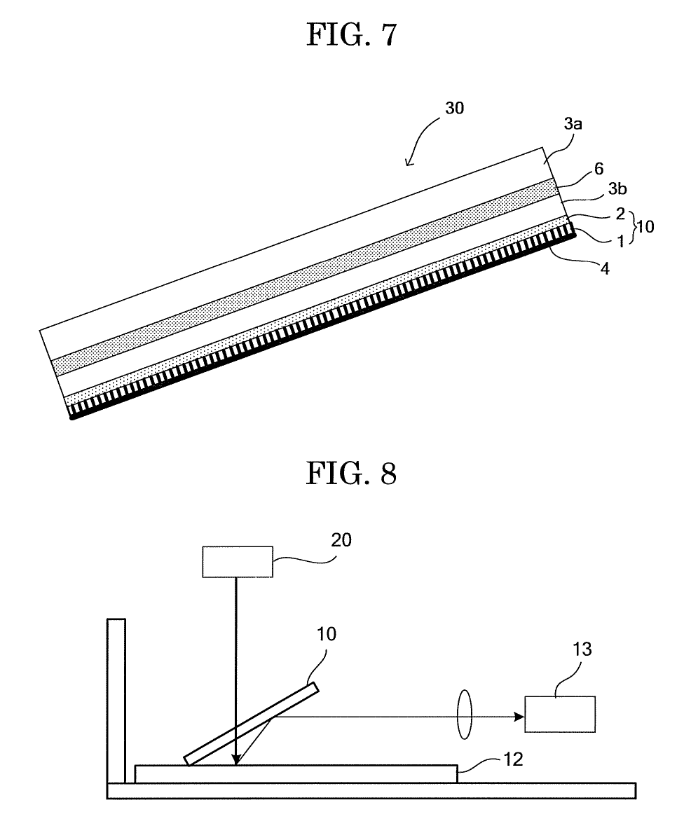

As shown in FIG. 4, the optical film is preferably formed on a surface of the base constituting a windshield 30, which surface is opposite from the surface from which light is incident (back surface). When the windshield 30 is a laminated glass containing an intermediate layer in between two plate glasses 3a and 3b, the optical film 10 (a vertically polarizing film 1 and π/2 optical rotation film 2) is used as an intermediate layer as shown in FIG. 6, or the optical film 10 is formed on the surface of the laminated glass, which is opposite from the surface from which light is incident (back surface) as shown in FIG. 7. In FIG. 7, 4 denotes an antireflection film and 6 denotes an intermediate layer.

Next, with reference to FIG. 4, the principle of preventing unwanted reflections (surrounding views reflected on glass) using glass containing the optical film 10 (a vertically polarizing film 1 and π/2 optical rotation film 2) of the present invention will be explained.

A recent car has a windshield 30 arranged at an angle of approximately 30 degrees from horizontal to decrease air resistance, thus a shadow of a dashboard 5, which obstructs the view of the driver in the car, is a light reflected to an inner surface of the windshield 30 at an incident angle of approximately 60 degrees.

In a vertically polarizing film 1, the transmission of a vertical polarizer is set to 90% in front face and 50% at an incident angle of 60 degrees.

When the sunlight I0 falls over at an elevation angle of 60 degrees, a light I1 through the windshield 30 becomes 0.9 times I0. Because a light I2 reflected from the dashboard 5 remains to be substantially ordinary light, it is necessary to use an antireflection film 4 which minimizes the light having an output angle of 60 degrees in the ordinary light I2. As a result, the intensity of I6 can be suppressed.

A light I3 entering the windshield 30 again enters the vertical polarizer in the vertically polarizing film 1 in a state of ordinary light. However, because I3 obliquely enters the vertical polarizer, only a polarization component I3p of the light I3, which has a wavefront in a plane containing the polarization axis of the vertical polarizer and the travel axis of the light I3, is absorbed and becomes I3s, and then I3s enters the π/2 optical rotation film 2 located closer to the outside than is the vertically polarizing film 1. I3s is changed from S wave component to P wave component by passing through the π/2 optical rotation film 2. The P wave component represented as I3pt is hardly reflected at the external interface of the windshield 30 (interface between glass and air) due to Brewster angle effect, and exit to the outside.

Even if some of S wave components remaining in the light I3pt become a return light I4, I4 is changed again to a P wave component by an optical rotator and absorbed in the vertical polarizer of the vertically polarizing film 1. Thus, a return light inside the car I5 is almost 0 in FIG. 4.

Here, a Brewster angle is an incident angle where light reflected at an interface of substances having different refractive indexes is completely polarized.

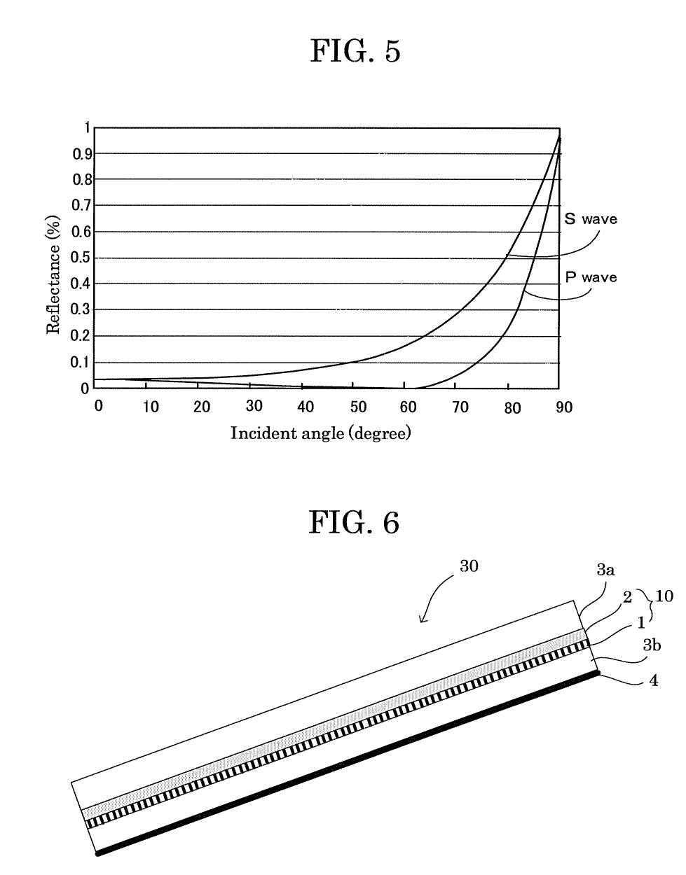

When light enters an interface of two substances having different refractive indexes at a certain angle, a reflectance of a horizontal polarization component (P polarization) relative to the incident angle and that of a vertical polarization component (S polarization) relative to the incident angle are different. As shown in FIG. 5, P polarization decreases to 0 at a Brewster angle and then increased thereafter. S polarization monotonically increases. As stated above, a visible light which enters glass having a refractive index of 1.46 from air having a refractive index of 1 has a Brewster angle of approximately 56 degrees.

### <Base>

For the base, glass (namely a glass base) is the most suitable. This is because glass has the best actual performance in that it has 12-year durability, which is the roughly-estimated operating life of vehicles under environments where they are exposed to wind and rain and do not disturb the polarization. However, recently, plastics, which have high-durability and high-isotropy and are rarely disturb polarization, for example norbornene polymers, are provided even in polymer plate products. Materials other than glass can be also used for the base.

### —Glass Base—

The glass base is not particularly limited and may be suitably selected in accordance with the intended use. Examples thereof include a single-layer glass, laminated glass, reinforced laminated glass, multi-layered glass, reinforced multi-layered glass, and laminated multi-layered glass.

Examples of the types of plate glasses constituting such glass base include a transparent plate glass, template glass, wire-included plate glass, line-included plate glass, reinforced plate glass, heat reflecting glass, heat absorbing glass, Low-E plate glass, and other various plate glasses.

The glass base may be a transparent colorless glass or a transparent colored glass as long as it is a transparent glass.

The thickness of the base glass is not particularly limited and may be suitably selected in accordance with the intended use, and, it is preferably 2 mm to 20 mm and more preferably 4 mm to 10 mm.

### —Laminated Glass—

The laminated glass is formed in a unit structure in which an intermediate layer intermediates in between two plate glasses. Such a laminated glass is widely used as windshields of vehicles such as automobiles and as windowpanes for buildings and the like because it is secure and broken pieces of glass do not fly apart even when affected by external impact. In a case of laminated glasses for automobiles, fairly thin laminated glasses have been used for the sake of weight saving, and glass has a thickness of 1 mm to 3 mm, and two of them are laminated via an adhesive layer having a thickness of 0.3 mm to 1 mm, thereby forming a laminated glass having a total thickness of approximately 3 mm to 6 mm.

The two plate glasses may be suitably selected from the above-mentioned various plate glasses in accordance with the intended use.

Examples of thermoplastic resins to be used for the intermediate layer include polyvinyl acetal resins, polyvinyl alcohol resins, polyvinyl chloride resins, saturated polyester resins, polyurethane resins, and ethylene-vinyl acetate copolymers. Of these, polyvinyl acetal resin is preferable because it allows for obtaining an intermediate layer that is excellent in a balance of various properties such as transparency, weather resistance, strength and bonding force. Polyvinyl butyral is particularly preferable.

The polyvinyl acetal resin is not particularly limited and may be suitably selected in accordance with the intended use. Examples thereof include polyvinyl formal resins that can be obtained by reacting polyvinyl alcohol (hereinafter occasionally abbreviated as PVA) with formaldehyde; narrowly defined polyvinyl acetal resins that can be obtained by reacting PVA with acetaldehyde; and polyvinyl butyral resins (hereinafter occasionally abbreviated as PVB) that can be obtained by reacting PVA with n-butylaldehyde.

PVA used for synthesis of the polyvinyl acetal resin is not particularly limited and may be suitably selected in accordance with the intended use, and a PVA having an average polymerization degree of 200 to 5,000 is preferably used, and a PVA having an average polymerization degree of 500 to 3,000 is more preferably used. When the average polymerization degree is less than 200, the strength of an intermediate layer formed using an obtained polyvinyl acetal resin may be excessively weak. When the average polymerization degree is more than 5,000, troubles may occur when a polyvinyl acetal resin is formed.

The polyvinyl acetal resin is not particularly limited and may be suitably selected in accordance with the intended use, and a polyvinyl acetal resin preferably has an acetalization degree of 40 mol % to 85 mol %, and more preferably an acetalization degree of 50 mol % to 75 mol %. It may be difficult to synthesize a polyvinyl acetal resin having an acetalization degree of less than 40 mol % or more than 85 mol % because of its reaction mechanism. The acetalization degree can be measured according to JIS K6728.

The intermediate layer contains the thermoplastic resin, and may further contain a plasticizer, a pigment, an adhesion adjustor, a coupling agent, a surfactant, an antioxidant, a thermal stabilizer, a light stabilizer, an ultraviolet absorbent, an infrared absorbent and the like, as necessary.

The method of forming the intermediate layer is not particularly limited and may be suitably selected in accordance with the intended use. For example, a method is exemplified in which a composition containing a thermoplastic resin and other components is uniformly kneaded and then the kneaded product is formed into a sheet by a conventional method such as an extrusion method, calendering method, pressing method, casting method and inflation method.

The thickness of the intermediate layer is not particularly limited and may be suitably selected in accordance with the intended use, and it is preferably 0.3 mm to 1.6 mm.

In the present invention, from the perspective of productivity and durability, it is preferable that the intermediate layer contain the optical film of the present invention. The optical film can also be formed on only one surface of a laminated glass.

The production method of the laminated glass is not particularly limited and may be suitably selected in accordance with the intended use. For example, the optical film of the present invention is sandwiched in between two transparent glass plates using an intermediate film, the laminated glass structure is put in a vacuum bag such as a rubber bag, the vacuum bag is connected to an exhaust system, the laminated glass structure is preliminarily bonded at a temperature of 70° C. to 110° C. while reducing the pressure and vacuuming or degassing so that the pressure in the vacuum bag is set as a depressurization degree of about −65 kPa to −100 kPa, then the preliminarily bonded laminated glass structure is put in an autoclave, heated at a temperature of 120° C. to 150° C. and pressurized under a pressure of 0.98 MPa to 1.47 MPa to actually bond it, thereby obtaining a desired laminated glass.

For other layers in the glass, a hard-coat layer, a front scattering layer, a primer layer, an antistatic layer, an undercoat layer, a protective layer and the like may be formed as necessary.

The optical film of the present invention has excellent prevention effect of unwanted reflections in a whole area of a windshield and wide areas including side window glasses in various kinds of vehicles without being influenced by shapes of windshields, thus the optical film of the present invention can preferably be used as window glasses for various kinds of vehicles such as automobiles, buses, autotrucks, electric trains, super express trains, airplanes, vessels and the like, and additionally used in various fields, as glass for building materials such as opening, partition and the like in buildings, for example common houses, complex housings, office buildings, stores, community facilities and industrial plants.

Moreover, as stated above, when glass having the optical film of the present invention is used for a windshield and side window glasses of a vehicle such as an automobile, reflected images of structures inside the vehicle such as a dashboard and unwanted reflections of outdoor light can be prevented, and safety for a driver can be ensured. Moreover, use of the glass of the present invention enables to use highly designable dashboards having such as one with bright colors and pictures which cannot have been conventionally used.

### EXAMPLES

Hereinafter, Examples of the present invention will be described, which however shall not be construed as limiting the scope of the present invention.

### Example 1

### Production of Optical Film

### —Preparation of Vertically Polarizing Film—

To a liquid crystal solution prepared by dissolving 3.04 g of a liquid crystal compound having a photo-polymerizable group (PALIOCOLOR LC242, manufactured by BASF) and 0.1 g of a polymer surfactant (MEGAFAC F780F by Dainippon Ink and Chemicals, Inc.) in 5.07 g of methyl ethyl ketone (MEK), 1.11 g of an initiator solution prepared by dissolving 0.90 g of IRGACURE 907 (manufactured by Chiba Specialty Chemicals K.K.) and 0.30 g of KAYACURE DETX (manufactured by Nippon Kayaku Co., Ltd.) in 8.80 g of methyl ethyl ketone (MEK), was added and stirred for 5 minutes to be fully dissolved, thereby obtaining a coating solution for vertically polarizing film.

Next, onto a surface of a 100 mm×100 mm triacetyl cellulose (TAC) film (TD80U by FUJIFILM CORPORATION) where a PVA orientation film was to be deposited, 10 mass % aqueous solution of polyvinyl alcohol (MP203 by Kuraray Co., Ltd.) was applied by spin coating at 500 rpm for 15 sec, and dried to obtain a PVA vertical orientation film.

Subsequently, the coating solution for vertically polarizing film was applied onto the PVA orientation film by spin coating at 1,000 rpm for 20 sec, and heated at 90° C. for 2 min in a thermostat, and then irradiated with an ultraviolet (UV) ray (a mercury xenon lamp, 200 W, 73 mJ/cm²) in a heated state. A cured liquid crystal film in which liquid crystal molecules were vertically oriented was thus obtained.

HAuCl₄.3H₂O (by Kanto Chemical Co., Inc) in a methyl ethyl ketone solution (5 mass %) was applied onto a surface of the obtained cured liquid crystal film by spin coating at 1,000 rpm for 30 sec and placed on a hotplate, in which the surface opposite to the coating surface was brought into contact with the hotplate, and the coated surface was irradiated with an ultraviolet (UV) ray (a mercury xenon lamp, 200 W, 876 mJ/cm²) in a heated state at 90° C. A vertically polarizing film was thus prepared.

When a section of the obtained vertically polarizing film was observed using a transmission electron microscope (TEM) (JEM-2010 by JEOL Ltd.), Au nanorods were substantially vertically oriented relative to the base surface. The Au nanorods had an average aspect ratio (major axis length/minor axis length) of 2.6.

### —Preparation of π/2 Optical Rotation Film—

To a liquid crystal solution prepared by dissolving 3.04 g of a liquid crystal compound having photopolymerizable groups (PALIOCOLOR LC242 manufactured by BASF) and 0.04 g of a chiral agent (PALIOCOLOR LC745 manufactured by BASF) in 5.07 g of methyl ethyl ketone (MEK), 1.11 g of a polymerization initiator solution prepared by dissolving 0.90 g of IRGACURE 907 (manufactured by Ciba Specialty Chemicals) and 0.30 g of KAYACURE DETX (manufactured by Nippon Kayaku Co., Ltd.) in 8.80 g of methyl ethyl ketone (MEK), was added and stirred for 5 minutes to be fully dissolved, thereby obtaining a coating solution for π/2 optical rotation film.

Next, the surface of the vertically polarizing film was subjected to rubbing treatment, and the coating solution for π/2 optical rotation film was applied thereon by spin coating at 1,000 rpm for 30 seconds and then irradiated with an ultraviolet (UV) ray (a mercury xenon lamp, 200 W, 876 mJ/cm²), while heated at 90° C. for 2 min in a thermostat. A π/2 optical rotation film was thus prepared.

Next, on the obtained laminate of vertically polarizing film and π/2 optical rotation film, an antireflection film was formed by the following process. An optical film of Example 1 was thus produced.

### —Preparation of Antireflection Film—

Metal titanium (Ti) and an n-type Si (phosphorus doped) single crystal having resistivity of 1.2 Ω·cm as a target were placed on a cathode in a vacuum chamber, and then the vacuum chamber was evacuated to 1.3×10⁻³ Pa (1×10⁻⁵ Torr). In the vacuum chamber, the laminate of vertically polarizing film and π/2 optical rotation was placed in such a manner that an antireflection film was deposited on the TAC base by sputtering by the following processes:

(1) First, as a discharge gas, a mixed gas of argon and nitrogen (10% of nitrogen) was introduced and conductance was adjusted, so that the vacuum chamber had a pressure of 0.27 Pa (2×10⁻³ Torr). Next, a negative DC voltage was applied to a Ti cathode and then a titanium nitride film was deposited by DC sputtering of a Ti target, which was a light absorption film having a thickness of 7.2 nm, extinction coefficient of 0.5 or more in a visible light range, extinction coefficient of 1.26 and refractive index of 1.9 at a wavelength of 550 nm.
(2) The gas introduction to the vacuum chamber was stopped, and then the interior thereof was brought to high vacuum, and as a discharge gas, a mixed gas of argon and nitrogen (33% of nitrogen) was introduced therein and conductance was adjusted, so that the vacuum chamber had a pressure of 0.27 Pa (2×10⁻³ Torr). Next, a DC voltage pulsed through SPARCLE-V (by ADVANCED ENERGY) was applied from a DC power source to an Si cathode and then a transparent silicon nitride film was deposited by intermittent DC sputtering of an Si target, which was a transparent nitride film having a thickness of 5 nm, extinction coefficient of 0.01 and refractive index of 1.93 at a wavelength of 550 nm.
(3) The gas introduction to the vacuum chamber was stopped, and then the interior thereof was brought to high vacuum, and as a discharge gas, oxygen gas (100%) was introduced therein and conductance was adjusted, so that the vacuum chamber had a pressure of 0.27 Pa (2×10⁻³ Torr). Next, a DC voltage pulsed through SPARCLE-V (by ADVANCED ENERGY) was applied from a DC power source to an Si cathode and then a silicon oxide film was deposited by intermittent DC sputtering of an Si target, which was an oxide film having a thickness of 122 nm and refractive index of 1.47 at a wavelength of 550 nm.

### Example 2

### Production of Optical Film

An optical film of Example 2 was produced in the same manner as in Example 1, except that 5 mass % of HAuCl₄.3H₂O (by Kanto Chemical Co., Inc) in a methyl ethyl ketone solution in the vertically polarizing film of Example 1 was replaced with 5 mass % of AgNO₃ (by Kanto Chemical Co., Inc) in a dimethylacetamide solution.

When a section of the obtained vertically polarizing film, which was a part of the optical film of Example 2 was observed using a transmission electron microscope (TEM) (JEM-2010 by JEOL Ltd.), Ag nanorods were substantially vertically oriented relative to a base surface. The Ag nanorods had an average aspect ratio (major axis length/minor axis length) of 2.8.

### Example 3

### Production of Optical Film

An optical film of Example 3 was produced in the same manner as in Example 1, except that the liquid crystal compound in the vertically polarizing film in Example 1 was change from LC242 to RM257 (by Merk Ltd.).

When a section of the obtained vertically polarizing film, which was a part of the optical film of Example 3 was observed using a transmission electron microscope (TEM) (JEM-2010 by JEOL Ltd.), Au nanorods were substantially vertically oriented relative to a base surface. The Au nanorods had an average aspect ratio (major axis length/minor axis length) of 2.7.

### Example 4

### Production of Optical Film

An optical film of Example 4 was produced in the same manner as in Example 1, except that the coating solution for vertically polarizing film prepared as described below was used, in which the vertical polarizer in the vertically polarizing film in Example 1 was changed from the metal nanorod to a dichroic dye.

### —Preparation of Coating Solution of Vertically Polarizing Film—

To a liquid crystal solution prepared by dissolving 3.04 g of a liquid crystal compound having photopolymerizable groups (PALIOCOLOR LC242 by BASF) and 0.1 g of a polymer surfactant (MEGAFAC F780F by Dainippon Ink and Chemicals, Inc.) in 5.07 g of methyl ethyl ketone (MEK), 1.11 g of an polymerization initiator solution prepared by dissolving 0.90 g of IRGACURE 907 (by Ciba Specialty Chemicals) and 0.30 g of KAYACURE DETX (by Nippon Kayaku Co., Ltd.) in 8.80 g of methyl ethyl ketone (MEK), was added and stirred for 5 minutes to be fully dissolved, thereby obtaining a solution.

Next, to the obtained solution, 0.023 g of dichroic azo dye G241 (by HAYASHIBARA BIOCHEMICAL LABS., INC.) and 0.005 g of dichroic azo dye G472 (by HAYASHIBARA BIOCHEMICAL LABS., INC.) were added and dispersed by ultrasonic wave for 5 minute to prepare a coating solution for vertically polarizing film.

### Example 5

### Production of Optical Film

An optical film of Example 5, in which π/2 optical rotation films were formed on both surfaces of the vertically polarizing film, was produced in the same manner as in Example 1, except that the PVA layer was also deposited to have a thickness of 1 μm on the TAC base surface of the vertically polarizing film prepared in Example 1, and that the both surfaces of the vertically polarizing film were subjected to rubbing treatment, and then the coating solution for π/2 optical rotation film in Example 1 was applied thereon to form π/2 optical rotation films.

### Comparative Example 1

### Conventional Horizontal Polarizer

An antireflection film was formed on a commercially available polarizing plate composed of iodine and PVA (manufactured by Sanritz Corporation) in the same manner as in Example 1.

### Comparative Example 2

### Production of Film Having a Polarizing Film in Which Gold Nanorods Were Horizontally Oriented by a Drawing Method

### —Synthesis of Gold Nanorods—

Gold nanorods were synthesized with reference to a Seed-Mediated method (C. J. Murphy et al., J. Phys. Chem. B, 105, 4065 (2001)).

First, 0.25 mL of a 0.01M HAuCl₄ aqueous solution was added to 7.5 mL of a 0.1M Cetyltrimethylammonium Bromide (CTAB) aqueous solution as a surfactant, and stirred for 5 minutes. As a reducer, 0.6 mL of an ice-cooled 0.01M NaBH₄ aqueous solution was added at once and intensively stirred for 1 minute, and then the color of the solution was changed from pale yellow to pale brown, thereby obtaining gold nanoparticles serving as seeds of gold nanorods.

Next, in a solution prepared by mixing 4.75 mL of a 0.1M CTAB aqueous solution, 0.2 ml, of a 0.01M HAuCl₄ aqueous solution and 0.03 mL of a 0.01M AgNO₃ aqueous solution, 0.032 mL of a 0.1M ascorbic acid aqueous solution was added and stirred, and then the color of the solution was changed from pale brown to transparent. To the obtained transparent solution, 0.01 ml, of the obtained solution of seed particles were added and mixed by gentle shaking several times, left to stand for 12 hours, and then the color of the solution was changed to red purple, thereby obtaining an aqueous solution of gold nanorods.

As the obtained aqueous solution of gold nanorods contained CTAB as a surfactant, it was purified by ultracentrifuge. Gold nanorods are settled by centrifugation at 14,000 rpm for 12 min. Thus, the process, in which a supernatant of the aqueous solution of gold nanorods is removed and pure water is added thereto and further centrifuged at 14,000 rpm for 12 minutes, was repeated three times. Subsequently, the supernatant was removed to obtain a concentrated aqueous solution of gold nanorods.

The obtained concentrated aqueous solution of gold nanorods was observed using a transmission electron microscope (TEM) (JEM-2010 by JEOL Ltd.), it was found that the gold nanorods had a minor-axis length of 12 nm, major axis length of 45 nm, aspect ratio of 3.8, and substantially uniform shape.

### —Production of Polyvinyl Alcohol Aqueous Solution in Which Gold Nanorods are Dispersed—

Polyvinyl alcohol (PVA-235, by KURARAY CO., LTD., saponification degree: 88%, mass average polymerization degree: 3,500) was dissolved in pure water to prepare 7.5 mass % aqueous polyvinyl alcohol solution, and then 0.5 g of aqueous solution of the synthesized gold nanorods was added thereto and stirred to prepare a polyvinyl alcohol aqueous solution in which gold nanorods were stably dispersed.

### —Preparation of Polarizing Film Containing Gold Nanorods—

The polyvinyl alcohol aqueous solution in which gold nanorods were dispersed was applied on a polyethylene terephthalate (PET) film by bar coating, and dried at 45° C. for 30 minutes to prepare a thin film having a dried thickness of 200 μm. The obtained thin film was separated from the PET film, and uniaxially drawn to six times the original length by a uniaxial drawing machine at 60° C. and 50% RH, thereby preparing a polarizing film in which gold nanorods were horizontally oriented.

A slice of the obtained horizontally polarized film was observed using a transmission electron microscope (TEM) (JEM-2010 by JEOL Ltd.), it was found that 80 number % or more of 500 pieces of gold nanorod were oriented at angles within ±10 degrees of vertical to the horizontal surface of the glass.

### Comparative Example 3

### Production of Optical Film

An optical film of Comparative Example 3 was produced in the same manner as in Example 1, except that a step of forming the π/2 optical rotation film in Example 1 was not performed. Thus, an optical film consisting of a vertically polarizing plate and antireflection film was obtained.

### Comparative Example 4

### Production of Optical Film

An optical film of Comparative Example 4 was produced in the same manner as in Example 1, except that the coating solution for π/2 optical rotation film was applied on a triacetyl cellulose film. Thus, an optical film consisting of a π/2 optical rotation film and antireflection film was obtained.

### Example 6

### Production of Laminated Glass

The optical film, which was a laminate without forming the antireflection layer in Example 1, was sandwiched in between two transparent PVB films, further both outer surfaces of the PVB films were covered with float glass plates, the laminate was put in a rubber bag, the rubber bag was deaerated at a vacuum degree of 2,660 Pa for 20 minutes and placed in an oven in a state of being deaerated and further subjected to a vacuum press while maintaining the temperature of 90° C. for 30 minutes. The laminated glass that was preliminarily bonded as described above was pressure-bonded in an autoclave for 20 minutes at 135° C. under a pressure of 118 N/cm² to thereby prepare a laminated glass. Then, an antireflection film was formed on a surface of the laminated glass by sputtering in the same manner as in Example 1. This surface was TAC film side of the optical film which was sandwiched inside the laminated glass.

### Example 7

### Production of Laminated Glass

A laminated glass of Example 7 was produced in the same manner as in Example 6, except that the optical film of Example 1 used in Example 6 was changed to the optical film of Example 4.

### Comparative Example 5

### Production of Laminated Glass

A laminated glass of Comparative Example 5 was produced in the same manner as in Example 6, except that the optical film of Example 1 used in Example 6 was changed to the optical film of Comparative Example 1.

### —Evaluation of Optical Properties—

The obtained optical films or laminated glass were respectively evaluated on unwanted reflections and light resistances in the following manner. The results are shown in Table 1.

### <Evaluation of Unwanted Reflections in Front and Oblique Direction>

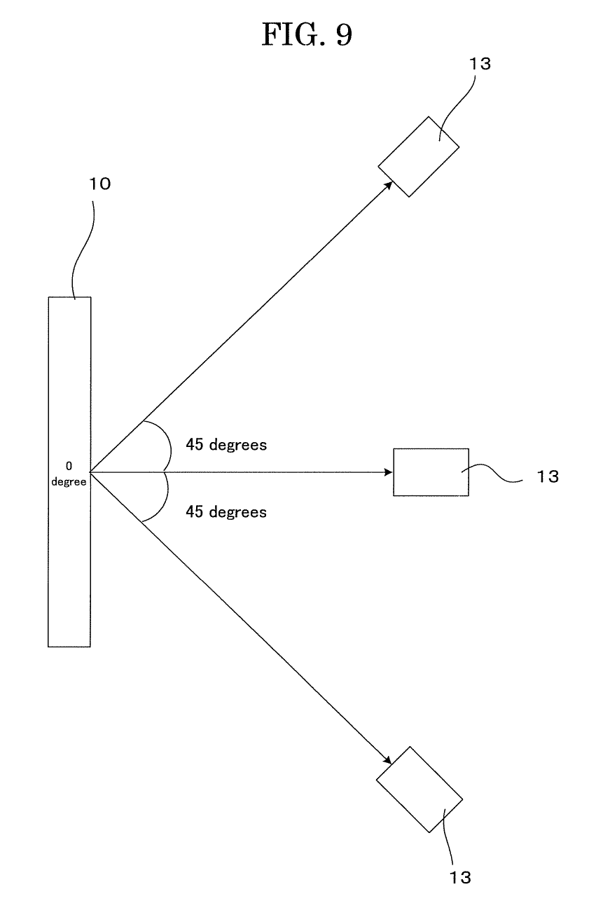

In a measurement device shown in FIGS. 8 and 9, a white paper was placed on a blue-colored glass plate 12 having a thickness of 6 mm, and then a produced optical film (laminated glass) 10 was placed thereon at an elevation angle of approximately 30 degrees to a horizontal reference plane, in which an antireflection film was deposited underside. A photoreceiver 13 was configured to enable to adjust an azimuth angle to be measured. FIG. 8 is a sketch of a horizontally viewed measurement device. FIG. 9 is a sketch of a measurement device viewed from above. “An azimuth angle to be measured” is a light receiving angle when the position of the photoreceiver 13 is changed in horizontal directions as shown in FIG. 9. The unwanted reflections in front and oblique directions (azimuth angles to be measured of 0 degree and 45 degrees) were evaluated in the following manner: by irradiating the optical film with light having a wavelength of 632.8 nm from a light source 20 (He—Ne laser), a power received in the photoreceiver 13 was measured, and the amount of the reduced light intensity was indicated in dB relative to the intensity when a normal glass was used. As the photoreceiver 13, an optical sensor (AQ2741 by Ando Electric Co., Ltd.) was used and arranged in Multimeter AQ2140 via an OPM unit AQ2730.

### <Evaluation of Light Resistance>

The optical films were respectively subjected to a light-exposure test using an ultra-high-pressure mercury lamp, and the light resistances thereof were evaluated based on changes in the unwanted reflections after irradiation for 1,000 hours.

TABLE 1

| | Unwanted reflections | | Light resistances | |
|---|---|---|---|---|
| | Front face | Oblique direction | | Oblique direction |
| | (azimuth angle | (azimuth angle | Front face (azimuth | (azimuth angle |
| | of 0 degree) | of 45 degrees) | angle of 0 degree) | of 45 degrees) |
| Example 1 | 4.6 dB | 4.6 dB | 4.1 dB | 4.1 dB |
| Example 2 | 5.0 dB | 5.0 dB | 4.7 dB | 4.7 dB |
| Example 3 | 4.6 dB | 4.6 dB | 4.2 dB | 4.2 dB |
| Example 4 | 5.0 dB | 5.0 dB | 2.1 dB | 1.2 dB |
| Example 5 | 6.8 dB | 6.8 dB | 6.2 dB | 6.2 dB |
| Example 6 | 4.6 dB | 4.6 dB | 4.4 dB | 4.4 dB |
| Example 7 | 5.0 dB | 5.0 dB | 2.5 dB | 1.5 dB |
| Comparative | 5.0 dB | 3.0 dB | 2.0 dB | 1.3 dB |
| Example 1 | | | | |
| Comparative | 4.2 dB | 2.6 dB | 3.8 dB | 2.1 dB |
| Example 2 | | | | |
| Comparative | 1.2 dB | 1.2 dB | 1.2 dB | 1.2 dB |
| Example 3 | | | | |
| Comparative | 1.1 dB | 1.1 dB | 1.0 dB | 1.0 dB |
| Example 4 | | | | |
| Comparative | 1.2 dB | 1.2 dB | 1.2 dB | 1.2 dB |
| Example 5 | | | | |

An optical film of the present invention has excellent prevention effect of unwanted reflections in a whole area of a windshield and wide areas including side window glasses in various kinds of vehicles without being influenced by shapes of windshields, and also excels in safety, and allows to use highly designable dashboards such as one with bright colors and pictures which cannot have been conventionally used. Therefore, the optical film of the present invention can be widely used for, for example, windshields, side window glasses, and the like in various vehicles such as automobiles, electric trains, super express trains, airplanes and the like.

What is claimed is:

1. An optical film comprising:
a vertically polarizing film having a polarizer whose absorption axis is substantially vertically oriented to a film surface; and
a π/2 optical rotation film containing an optical rotator for rotating a vibration direction of linearly polarized light by substantially 90 degrees.

2. The optical film according to claim 1, wherein the π/2 optical rotation film is formed on both surfaces of the vertically polarizing film.

3. The optical film according to claim 1, further comprising an antireflection film.

4. The optical film according to claim 1, wherein the absorption axis of the polarizer in the vertically polarizing film is oriented at an angle of 80 degrees to 90 degrees to a surface of the vertically polarizing film.

5. The optical film according to claim 1, wherein the polarizer comprises an anisotropically absorbing material.

6. The optical film according to claim 5, wherein the anisotropically absorbing material is any one of a dichroic dye, anisotropic metal nanoparticle and carbon nanotube.

7. The optical film according to claim 6, wherein the anisotropic metal nanoparticle comprises at least one selected from gold, silver, copper and aluminum.

8. A glass comprising:
a base; and
an optical film,
wherein the optical film comprises:
a vertically polarizing film having a polarizer whose absorption axis is substantially vertically oriented to a film surface; and
a π/2 optical rotation film containing an optical rotator for rotating a vibration direction of linearly polarized light by substantially 90 degrees.

9. The glass according to claim 8, wherein when the glass is placed so that sunlight is incident from one surface of the base, the optical film is located on the other surface of the base from which the sunlight is not incident.

10. The glass according to claim 9, wherein the base is a laminated glass in which an intermediate layer is provided in between two glass plates, and the intermediate layer comprises an optical film.

11. The glass according to claim 8, wherein the glass can be used for at least any of a windshield and side window glass of a vehicle.

12. The glass according to claim 11, wherein the vehicle is an automobile.
